(19) United States
(12) Patent Application Publication
(10) Pub. No.: US 2019/0114362 A1
(43) Pub. Date: Apr. 18, 2019

(54) Searching Online Social Networks Using Entity-based Embeddings

(71) Applicant: Facebook, Inc., Menlo Park, CA (US)

(72) Inventors: Karthik Subbian, Cupertino, CA (US); Haixun Wang, Palo Alto, CA (US); Oleksandr Maksymets, Menlo Park, CA (US)

(21) Appl. No.: 15/782,475

(22) Filed: Oct. 12, 2017

(51) Int. Cl. G06F 17/30; G06Q 50/00; H04L 29/08

(52) U.S. Cl. CPC G06F 17/30867; G06Q 50/01; H04L 67/306; G06F 17/3053; G06F 17/30958

(57) ABSTRACT

In one embodiment, a method includes receiving, from a client system associated with a user of an online social network, a search query for entities in the online social network, the search query containing one or more n-grams, generating a query embedding corresponding to the search query, where the query embedding represents the search query as a point in a d-dimensional embedding space, retrieving multiple entity embeddings corresponding to a plurality of entities, respectively, where each entity embedding represents the corresponding entity as a point in the d-dimensional embedding space, calculating, for each of the retrieved entity embeddings, a similarity metric between the query embedding and the entity embedding, ranking the entities based on their respective calculated similarity metrics, and sending, to the client system in response to the search query, instructions for presenting a search-results interface.

### TECHNICAL FIELD

This disclosure generally relates to social graphs and performing searches for objects within a social-networking environment.

### BACKGROUND

A social-networking system, which may include a social-networking website, may enable its users (such as persons or organizations) to interact with it and with each other through it. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g. wall posts, photo-sharing, event organization, messaging, games, or advertisements) to facilitate social interaction between or among users.

The social-networking system may send over one or more networks content or messages related to its services to a mobile or other computing device of a user. A user may also install software applications on a mobile or other computing device of the user for accessing a user profile of the user and other data within the social-networking system. The social-networking system may generate a personalized set of content objects to display to a user, such as a newsfeed of aggregated stories of other users connected to the user.

Social-graph analysis views social relationships in terms of network theory consisting of nodes and edges. Nodes represent the individual actors within the networks, and edges represent the relationships between the actors. The resulting graph-based structures are often very complex. There can be many types of nodes and many types of edges for connecting nodes. In its simplest form, a social graph is a map of all of the relevant edges between all the nodes being studied.

### SUMMARY OF PARTICULAR EMBODIMENTS

In particular embodiments, the social-networking system may generate embeddings for entities, such as pages, groups, and users, in the same embedding space as term embeddings based on an entity embedding model. The entity embedding model may be an extension of a paragraph2vector model introduced in Q. Le and T. Mikolov [Ref. 1] to cover generating embeddings for entities in an online social network, and thus may be thought of as an “entity2vector” model. The entity embeddings may be used in search ranking, entity disambiguation, intent classification, group search, typeahead, and other suitable applications. Users of the online social network may search for various entities in the online social network including pages, groups, and users, with a short query term string. Word embeddings have been used to process such query requests. However, an entity (e.g., a page) usually comprises a large number of terms. Thus, processing a search request based on word embeddings may be computationally expensive. Entity embeddings may provide a computationally less expensive alternative solution for processing search queries for entities in the online social network. The entity embeddings may be useful in computing the similarity of a query to an entity, computing nearest neighbors to an entity, and discovering terms or entities (e.g., pages, groups, or users) within a certain distance from the given query or entity within an embedding space. Based on a large corpus of training data, a term embedding matrix (also known as a term embedding table) may be created. The term embedding matrix may comprise unigrams and selected n-grams. Entity embeddings may be generated by a backpropagation technique with the given term embedding matrix to form an entity embedding matrix (also known as an entity embedding table). Not all entities may comprise enough content. A page may have only few words, which may not be enough to properly represent the page. The social-networking system may use entity embedding inference techniques to generate an embedding for the page. As an example and not by way of limitation, the official page of Manchester United (MU), the English Premier League football team, may be a relatively inactive page, with few posts and therefore little text to analyze. To generate an embedding for the official page of MU, the system may infer an embedding based on more active co-visited entities, such as Ryan Giggs (a former MU player) and Paul Pogba (a current MU player). When the social-networking system receives a query “Manchester United,” the social-networking system may generate a query embedding for the given query and find entities that have corresponding entity embeddings similar to the query embedding. In response to the query for “Manchester United,” the pages for Giggs and Pogba along with the official page of the MU would be ranked high in the search results even though pages for Giggs and Pogba may not have a high text matching to the query. Processing queries based on entity embeddings may improve over simpler text matching systems that may have up-ranked pages with more terms matching the query (e.g., the page for the city of Manchester), which may be a poor match for the intent of the query. Experiments shows that query processing based on entity embeddings outperformed the traditional query processing based on text matching by improving Mean Average Precision (MAP) by 38.5%. Entity embeddings may also improve query processing time because processing search results based on word embeddings may require more computing resources and processing time compared to the processing based on entity embeddings.

In particular embodiments, the social-networking system may receive a trigger to deploy a new version of the entity embeddings stored in the one or more production data stores. The trigger may be an expiration of a version update timer associated with the entity embeddings stored in the one or more production data stores. The social-networking system may create a new term embedding matrix, each column of which corresponds to a unigram or a pre-identified bi-gram appearing in a corpus of text extracted from objects in the online social network. In order to create the new term embedding matrix, the social-networking system may prepare an initialized term embedding matrix on one or more temporary data stores. The one or more temporary data stores may be apart from the one or more production data stores. Each column of the initialized term embedding matrix corresponds to one of the unigrams or the pre-identified bi-grams appearing in the corpus of text. The social-networking system may train term embeddings in the initialized term embedding matrix using a term embedding model. The term embedding model may use a stochastic gradient descent process with a gradient obtained via backpropagation. The term embedding model may be a word2vec model. The social-networking system may create, using term embeddings in the created term embedding matrix, a new entity embedding matrix, each column of which corresponds to an eligible entity in the online social network. An eligible entity is an entity that can be represented by an entity embedding. In order to create the new entity embedding matrix, the social-networking system may identify eligible entities in the online social network from one or more verticals in the online social network. The social-networking system may, for each eligible entity, select text to be used for generating an entity embedding corresponding to the entity. The selected text has a determined probability of being relevant to the entity greater than a threshold probability. The social-networking system may determine, for each eligible entity, whether the selected text is sufficient to represent the entity. Such determination may be based on an amount of the selected text. The social-networking system may add each eligible entity to a training entity pool if the selected text for the eligible entity is determined to be sufficient to represent the entity. The social-networking system may add each eligible entity to an inference entity pool if the selected text for the eligible entity is determined not sufficient to represent the entity.

The social-networking system may prepare an initialized entity embedding matrix, on one or more temporary data stores. Each column of the initialized entity embedding matrix corresponds to one of the entities in the training entity pool. The social-networking system may train entity embeddings in the initialized entity embedding matrix using an entity embedding model that uses a stochastic gradient descent process with a gradient obtained via backpropagation. In particular embodiments, the entity embedding model may be a distributed memory model. With the distributed memory model, the social-networking system may associate, for each entity in the training entity pool, an entity identifier for the entity and the corresponding initialized entity embedding in the initialized entity embedding matrix. The social-networking system may retrieve, for each entity in the training entity pool, term embeddings corresponding to terms in the selected text from the term embedding matrix. The social-networking system may iteratively train the initialized entity embedding matrix using the stochastic gradient descent process. In an iteration of the stochastic gradient descent process, the social-networking system may sample, for each entity in the training entity pool, a term sequence of k terms from a sliding window over the selected text, where k is a fixed-length of the term sequence and the social-networking system may perform a backpropagation process on a current iteration of the initialized entity embedding matrix in order to maximize, for each entity embedding in the entity embedding matrix, a probability that an embedding vector that is a combination of the entity embedding and term embeddings corresponding to the first k-1 terms of the sampled term sequence correctly predicts a k-th term in the term sequence. The combination of the entity embedding and term embeddings may comprise taking an average of the entity embedding and the term embeddings. In particular embodiments, the combination of the entity embedding and term embeddings may comprise concatenating the entity embedding with the term embeddings. In particular embodiments, the entity embedding model may be a distributed bag-of-words model. With the distributed bag-of-words model, the social-networking system may associate, for each entity in the training entity pool, an entity identifier for the entity and the corresponding initialized entity embedding in the initialized entity embedding matrix. The social-networking system may iteratively train the initialized entity embedding matrix using the stochastic gradient descent process. In each iteration of the stochastic gradient descent process, the social-networking system may sample, for each entity in the training entity pool, a term sequence of k-terms from a sliding window over the selected text, where k is a fixed-length of the term sequence and the social-networking system may perform a backpropagation process on a current iteration of the initialized entity embedding matrix in order to maximize, for each entity embedding in the entity embedding matrix, a probability that the entity embedding correctly predicts each term in the sampled term sequence.

In particular embodiments, after training entity embeddings for the eligible entities in the training entity pool, the social-networking system may generate an entity embedding for each entity in the inference entity pool by performing an embedding interpolation. For the embedding interpolation, for each entity in the inference entity pool, the social-networking system may identify one or more neighboring entities of the entity that have entity embeddings stored in the one or more temporary data stores from a social graph of the online social network. The social-networking system may determine a weight for each edge connecting the entity and each of the identified one or more neighboring entity. The weight for each edge may be proportional to the number of co-visits by users of the online social network to the entity and the identified neighboring entity. The weights may be normalized so that a sum of the weights is 1. The social-networking system may generate an entity embedding corresponding to the entity by taking a weighted average of entity embeddings corresponding to the identified neighboring entities. If a first entity in the inference entity pool has no neighboring entities with an entity embedding stored in the one or more temporary data stores in the social graph of the online social network, then the social-networking system may, for the embedding interpolation for the first entity, determine a weight for each edge connecting two entities within a threshold degree of separation of the first entity in the social graph. The social-networking system may calculate a number of recorded visits per entity using a repeated random walk with restart on the social graph for a pre-determined number of random walks. For a random walk with restart procedure, the social-networking system may set a node representing the first entity to a source node. The social-networking system may perform a walk from the source node to a neighboring destination node in the social graph of the online social network. Walking to the destination node makes the destination node a source node for a next walk. When more than one neighboring nodes are available from the source node, the neighboring destination node is randomly chosen based on the determined weights on the edges between the source node and the neighboring nodes. The social-networking system may repeat the walks for a randomly chosen number of times and record, at the end of the walks for the randomly chosen number of times, a second entity represented by the destination node if the second entity has a corresponding entity embedding. After performing random walk with restart procedures for a pre-determined number of times, the social-networking system may calculate, for each of the recorded second entities, a similarity of the first entity to the second entity based on a number of recorded visits to the second entity out of a total number of recorded visits. The social-networking system may generate an entity embedding for the first entity by taking a weighted average of entity embeddings corresponding to the recorded second entities, where the applied weights in the weighted average are proportional to the calculated similarities, and the applied weights are normalized so that a sum of the weights is 1. Once the social-networking system generates an entity embedding for an entity in the inference entity pool, the social-networking system may add the generated entity embedding into the entity embedding matrix.

In particular embodiments, the social-networking system may, once creating the new term embedding matrix and the new entity embedding matrix has completed, replace an existing term embedding matrix with the new term embedding matrix and an existing entity embedding matrix with the new entity embedding matrix on the one or more production data stores.

In particular embodiments, the social-networking system may receive a search query for entities in an online social network from a client system associated with a user of the online social network, where entities comprise one or more of pages, groups, or users. The search query may comprise one or more n-grams. The social-networking system may generate a query embedding corresponding to the search query using an entity embedding model. In order to generate the query embedding, the social-networking system may parse the search query to identify one or more unique entities associated with the online social network referenced in the search query and generate one or more term embeddings representing the one or more n-grams of the search query, respectively, using a term embedding model. The query embedding represents the search query as a point in a d-dimensional embedding space. Each term embedding for an n-gram referencing one of the unique entities is a term embedding for the respective unique entity. The social-networking system may generate, using the entity embedding model, a query embedding using the generated term embeddings corresponding to the search query. The social-networking system may identify one or more entities in the online social networking matching the one or more n-grams of the search query. The social-networking system may retrieve a plurality of entity embeddings corresponding to a plurality of entities, respectively, from one or more production data stores. Each entity embedding represents the corresponding entity as a point in the d-dimensional embedding space. The social-networking system may calculate a similarity metric between the query embedding and the entity embedding for each of the retrieved entity embeddings. The similarity metric measures a degree of similarity of the query embedding to the entity embedding. The similarity metric may be a cosign similarity. The social-networking system may rank the entities based on their respective calculated similarity metrics. The social-networking system may send instructions for presenting a search-results interface to the client system in response to the search query. The search-results interface may comprise one or more search results corresponding to one or more of the entities, respectively, where the one or more search results may be presented in ranked order based on the rankings of their corresponding entities.

The embodiments disclosed herein are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example network environment associated with a social-networking system.

FIG. 2 illustrates an example social graph.

FIG. 3 illustrates an example partitioning for storing objects of a social-networking system.

FIG. 4 illustrates an example view of an embedding space.

FIG. 5 illustrates an example artificial neural network.

FIG. 6 illustrates an example process of deploying a new version of entity embeddings.

FIG. 7 illustrates an example training process of the distributed memory model.

FIG. 8 illustrates an example training process of the distributed bag of words model.

FIG. 9A-9B illustrate examples of neighboring entities in the social graph.

FIG. 10 illustrates an example method for processing a query for entities in the online social network with pre-calculated entity embeddings.

FIG. 11 illustrates a performance comparison for query clicks.

FIG. 12 illustrates a performance comparison for entity disambiguation.

FIG. 13 illustrates an example computer system.

### DESCRIPTION OF EXAMPLE EMBODIMENTS

### System Overview

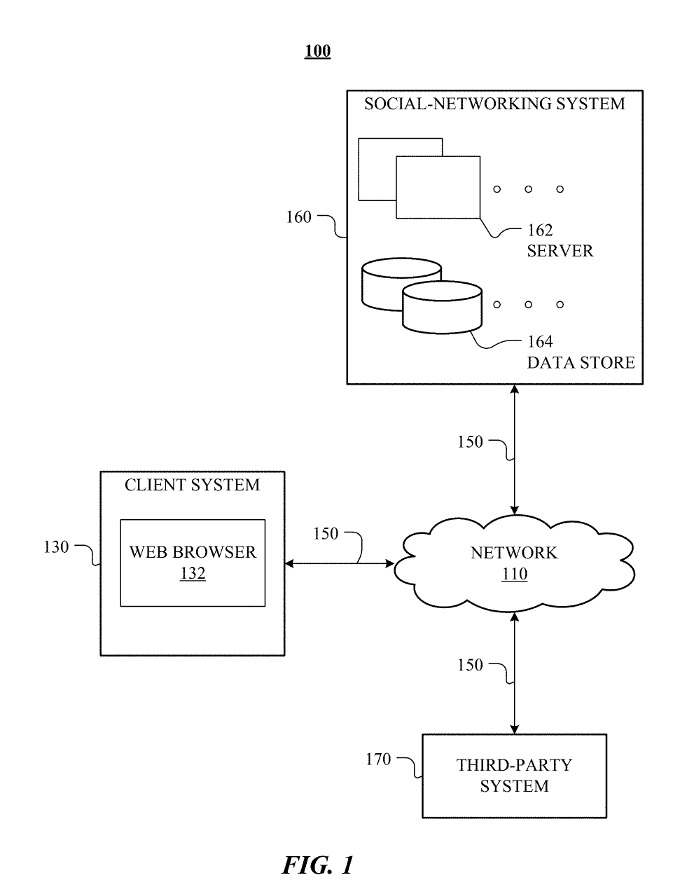

FIG. 1 illustrates an example network environment 100 associated with a social-networking system. Network environment 100 includes a client system 130, a social-networking system 160, and a third-party system 170 connected to each other by a network 110. Although FIG. 1 illustrates a particular arrangement of a client system 130, a social-networking system 160, a third-party system 170, and a network 110, this disclosure contemplates any suitable arrangement of a client system 130, a social-networking system 160, a third-party system 170, and a network 110. As an example and not by way of limitation, two or more of a client system 130, a social-networking system 160, and a third-party system 170 may be connected to each other directly, bypassing a network 110. As another example, two or more of a client system 130, a social-networking system 160, and a third-party system 170 may be physically or logically co-located with each other in whole or in part. Moreover, although FIG. 1 illustrates a particular number of client systems 130, social-networking systems 160, third-party systems 170, and networks 110, this disclosure contemplates any suitable number of client systems 130, social-networking systems 160, third-party systems 170, and networks 110. As an example and not by way of limitation, network environment 100 may include multiple client systems 130, social-networking systems 160, third-party systems 170, and networks 110.

This disclosure contemplates any suitable network 110. As an example and not by way of limitation, one or more portions of a network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. A network 110 may include one or more networks 110.

Links 150 may connect a client system 130, a social-networking system 160, and a third-party system 170 to a communication network 110 or to each other. This disclosure contemplates any suitable links 150. In particular embodiments, one or more links 150 include one or more wireline (such as for example Digital Subscriber Line (DSL) or Data Over Cable Service Interface Specification (DOC SIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout a network environment 100. One or more first links 150 may differ in one or more respects from one or more second links 150.

In particular embodiments, a client system 130 may be an electronic device including hardware, software, or embedded logic components or a combination of two or more such components and capable of carrying out the appropriate functionalities implemented or supported by a client system 130. As an example and not by way of limitation, a client system 130 may include a computer system such as a desktop computer, notebook or laptop computer, netbook, a tablet computer, e-book reader, GPS device, camera, personal digital assistant (PDA), handheld electronic device, cellular telephone, smartphone, other suitable electronic device, or any suitable combination thereof. This disclosure contemplates any suitable client systems 130. A client system 130 may enable a network user at a client system 130 to access a network 110. A client system 130 may enable its user to communicate with other users at other client systems 130.

In particular embodiments, a client system 130 may include a web browser 132, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at a client system 130 may enter a Uniform Resource Locator (URL) or other address directing a web browser 132 to a particular server (such as server 162, or a server associated with a third-party system 170), and the web browser 132 may generate a Hyper Text Transfer Protocol (HTTP) request and communicate the HTTP request to server. The server may accept the HTTP request and communicate to a client system 130 one or more Hyper Text Markup Language (HTML) files responsive to the HTTP request. The client system 130 may render a web interface (e.g. a webpage) based on the HTML files from the server for presentation to the user. This disclosure contemplates any suitable source files. As an example and not by way of limitation, a web interface may be rendered from HTML files, Extensible Hyper Text Markup Language (XHTML) files, or Extensible Markup Language (XML) files, according to particular needs. Such interfaces may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a web interface encompasses one or more corresponding source files (which a browser may use to render the web interface) and vice versa, where appropriate.

In particular embodiments, the social-networking system 160 may be a network-addressable computing system that can host an online social network. The social-networking system 160 may generate, store, receive, and send social-networking data, such as, for example, user-profile data, concept-profile data, social-graph information, or other suitable data related to the online social network. The social-networking system 160 may be accessed by the other components of network environment 100 either directly or via a network 110. As an example and not by way of limitation, a client system 130 may access the social-networking system 160 using a web browser 132, or a native application associated with the social-networking system 160 (e.g., a mobile social-networking application, a messaging application, another suitable application, or any combination thereof) either directly or via a network 110. In particular embodiments, the social-networking system 160 may include one or more servers 162. Each server 162 may be a unitary server or a distributed server spanning multiple computers or multiple datacenters. Servers 162 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 162 may include hardware, software, or embedded logic components or a combination of two or more such components for carrying out the appropriate functionalities implemented or supported by server 162. In particular embodiments, the social-networking system 160 may include one or more data stores 164. Data stores 164 may be used to store various types of information. In particular embodiments, the information stored in data stores 164 may be organized according to specific data structures. In particular embodiments, each data store 164 may be a relational, columnar, correlation, or other suitable database. Although this disclosure describes or illustrates particular types of databases, this disclosure contemplates any suitable types of databases. Particular embodiments may provide interfaces that enable a client system 130, a social-networking system 160, or a third-party system 170 to manage, retrieve, modify, add, or delete, the information stored in data store 164.

In particular embodiments, the social-networking system 160 may store one or more social graphs in one or more data stores 164. In particular embodiments, a social graph may include multiple nodes—which may include multiple user nodes (each corresponding to a particular user) or multiple concept nodes (each corresponding to a particular concept)—and multiple edges connecting the nodes. The social-networking system 160 may provide users of the online social network the ability to communicate and interact with other users. In particular embodiments, users may join the online social network via the social-networking system 160 and then add connections (e.g., relationships) to a number of other users of the social-networking system 160 whom they want to be connected to. Herein, the term “friend” may refer to any other user of the social-networking system 160 with whom a user has formed a connection, association, or relationship via the social-networking system 160.

In particular embodiments, the social-networking system 160 may provide users with the ability to take actions on various types of items or objects, supported by the social-networking system 160. As an example and not by way of limitation, the items and objects may include groups or social networks to which users of the social-networking system 160 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in the social-networking system 160 or by an external system of a third-party system 170, which is separate from the social-networking system 160 and coupled to the social-networking system 160 via a network 110.

In particular embodiments, the social-networking system 160 may be capable of linking a variety of entities. As an example and not by way of limitation, the social-networking system 160 may enable users to interact with each other as well as receive content from third-party systems 170 or other entities, or to allow users to interact with these entities through an application programming interfaces (API) or other communication channels.

In particular embodiments, a third-party system 170 may include one or more types of servers, one or more data stores, one or more interfaces, including but not limited to APIs, one or more web services, one or more content sources, one or more networks, or any other suitable components, e.g., that servers may communicate with. A third-party system 170 may be operated by a different entity from an entity operating the social-networking system 160. In particular embodiments, however, the social-networking system 160 and third-party systems 170 may operate in conjunction with each other to provide social-networking services to users of the social-networking system 160 or third-party systems 170. In this sense, the social-networking system 160 may provide a platform, or backbone, which other systems, such as third-party systems 170, may use to provide social-networking services and functionality to users across the Internet.

In particular embodiments, a third-party system 170 may include a third-party content object provider. A third-party content object provider may include one or more sources of content objects, which may be communicated to a client system 130. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, the social-networking system 160 also includes user-generated content objects, which may enhance a user's interactions with the social-networking system 160. User-generated content may include anything a user can add, upload, send, or “post” to the social-networking system 160. As an example and not by way of limitation, a user communicates posts to the social-networking system 160 from a client system 130. Posts may include data such as status updates or other textual data, location information, photos, videos, links, music or other similar data or media. Content may also be added to the social-networking system 160 by a third-party through a “communication channel,” such as a newsfeed or stream.

In particular embodiments, the social-networking system 160 may include a variety of servers, sub-systems, programs, modules, logs, and data stores. In particular embodiments, the social-networking system 160 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. The social-networking system 160 may also include suitable components such as network interfaces, security mechanisms, load balancers, failover servers, management-and-network-operations consoles, other suitable components, or any suitable combination thereof. In particular embodiments, the social-networking system 160 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking the social-networking system 160 to one or more client systems 130 or one or more third-party systems 170 via a network 110. The web server may include a mail server or other messaging functionality for receiving and routing messages between the social-networking system 160 and one or more client systems 130. An API-request server may allow a third-party system 170 to access information from the social-networking system 160 by calling one or more APIs. An action logger may be used to receive communications from a web server about a user's actions on or off the social-networking system 160. In conjunction with the action log, a third-party-content-object log may be maintained of user exposures to third-party-content objects. A notification controller may provide information regarding content objects to a client system 130. Information may be pushed to a client system 130 as notifications, or information may be pulled from a client system 130 responsive to a request received from a client system 130. Authorization servers may be used to enforce one or more privacy settings of the users of the social-networking system 160. A privacy setting of a user determines how particular information associated with a user can be shared. The authorization server may allow users to opt in to or opt out of having their actions logged by the social-networking system 160 or shared with other systems (e.g., a third-party system 170), such as, for example, by setting appropriate privacy settings. Third-party-content-object stores may be used to store content objects received from third parties, such as a third-party system 170. Location stores may be used for storing location information received from client systems 130 associated with users. Advertisement-pricing modules may combine social information, the current time, location information, or other suitable information to provide relevant advertisements, in the form of notifications, to a user.

### Social Graphs

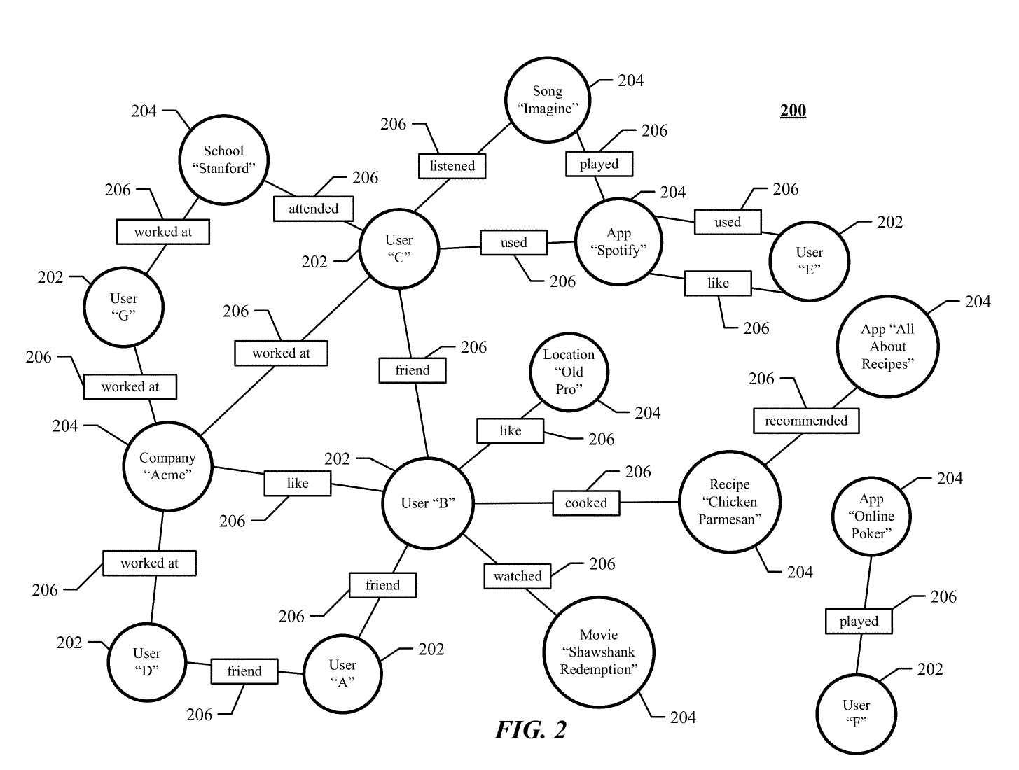

FIG. 2 illustrates an example social graph 200. In particular embodiments, the social-networking system 160 may store one or more social graphs 200 in one or more data stores. In particular embodiments, the social graph 200 may include multiple nodes—which may include multiple user nodes 202 or multiple concept nodes 204—and multiple edges 206 connecting the nodes. The example social graph 200 illustrated in FIG. 2 is shown, for didactic purposes, in a two-dimensional visual map representation. In particular embodiments, a social-networking system 160, a client system 130, or a third-party system 170 may access the social graph 200 and related social-graph information for suitable applications. The nodes and edges of the social graph 200 may be stored as data objects, for example, in a data store (such as a social-graph database). Such a data store may include one or more searchable or queryable indexes of nodes or edges of the social graph 200.

In particular embodiments, a user node 202 may correspond to a user of the social-networking system 160. As an example and not by way of limitation, a user may be an individual (human user), an entity (e.g., an enterprise, business, or third-party application), or a group (e.g., of individuals or entities) that interacts or communicates with or over the social-networking system 160. In particular embodiments, when a user registers for an account with the social-networking system 160, the social-networking system 160 may create a user node 202 corresponding to the user, and store the user node 202 in one or more data stores. Users and user nodes 202 described herein may, where appropriate, refer to registered users and user nodes 202 associated with registered users. In addition or as an alternative, users and user nodes 202 described herein may, where appropriate, refer to users that have not registered with the social-networking system 160. In particular embodiments, a user node 202 may be associated with information provided by a user or information gathered by various systems, including the social-networking system 160. As an example and not by way of limitation, a user may provide his or her name, profile picture, contact information, birth date, sex, marital status, family status, employment, education background, preferences, interests, or other demographic information. In particular embodiments, a user node 202 may be associated with one or more data objects corresponding to information associated with a user. In particular embodiments, a user node 202 may correspond to one or more web interfaces.

In particular embodiments, a concept node 204 may correspond to a concept. As an example and not by way of limitation, a concept may correspond to a place (such as, for example, a movie theater, restaurant, landmark, or city); a website (such as, for example, a website associated with the social-networking system 160 or a third-party website associated with a web-application server); an entity (such as, for example, a person, business, group, sports team, or celebrity); a resource (such as, for example, an audio file, video file, digital photo, text file, structured document, or application) which may be located within the social-networking system 160 or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 204 may be associated with information of a concept provided by a user or information gathered by various systems, including the social-networking system 160. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 204 may be associated with one or more data objects corresponding to information associated with concept node 204. In particular embodiments, a concept node 204 may correspond to one or more web interfaces.

In particular embodiments, a node in the social graph 200 may represent or be represented by a web interface (which may be referred to as a “profile interface”). Profile interfaces may be hosted by or accessible to the social-networking system 160. Profile interfaces may also be hosted on third-party websites associated with a third-party system 170. As an example and not by way of limitation, a profile interface corresponding to a particular external web interface may be the particular external web interface and the profile interface may correspond to a particular concept node 204. Profile interfaces may be viewable by all or a selected subset of other users. As an example and not by way of limitation, a user node 202 may have a corresponding user-profile interface in which the corresponding user may add content, make declarations, or otherwise express himself or herself. As another example and not by way of limitation, a concept node 204 may have a corresponding concept-profile interface in which one or more users may add content, make declarations, or express themselves, particularly in relation to the concept corresponding to concept node 204.

In particular embodiments, a concept node 204 may represent a third-party web interface or resource hosted by a third-party system 170. The third-party web interface or resource may include, among other elements, content, a selectable or other icon, or other inter-actable object (which may be implemented, for example, in JavaScript, AJAX, or PHP codes) representing an action or activity. As an example and not by way of limitation, a third-party web interface may include a selectable icon such as “like,” “check-in,” “eat,” “recommend,” or another suitable action or activity. A user viewing the third-party web interface may perform an action by selecting one of the icons (e.g., “check-in”), causing a client system 130 to send to the social-networking system 160 a message indicating the user's action. In response to the message, the social-networking system 160 may create an edge (e.g., a check-in-type edge) between a user node 202 corresponding to the user and a concept node 204 corresponding to the third-party web interface or resource and store edge 206 in one or more data stores.

In particular embodiments, a pair of nodes in the social graph 200 may be connected to each other by one or more edges 206. An edge 206 connecting a pair of nodes may represent a relationship between the pair of nodes. In particular embodiments, an edge 206 may include or represent one or more data objects or attributes corresponding to the relationship between a pair of nodes. As an example and not by way of limitation, a first user may indicate that a second user is a “friend” of the first user. In response to this indication, the social-networking system 160 may send a “friend request” to the second user. If the second user confirms the “friend request,” the social-networking system 160 may create an edge 206 connecting the first user's user node 202 to the second user's user node 202 in the social graph 200 and store edge 206 as social-graph information in one or more of data stores 164. In the example of FIG. 2, the social graph 200 includes an edge 206 indicating a friend relation between user nodes 202 of user “A” and user “B” and an edge indicating a friend relation between user nodes 202 of user “C” and user “B.” Although this disclosure describes or illustrates particular edges 206 with particular attributes connecting particular user nodes 202, this disclosure contemplates any suitable edges 206 with any suitable attributes connecting user nodes 202. As an example and not by way of limitation, an edge 206 may represent a friendship, family relationship, business or employment relationship, fan relationship (including, e.g., liking, etc.), follower relationship, visitor relationship (including, e.g., accessing, viewing, checking-in, sharing, etc.), sub scriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in the social graph 200 by one or more edges 206.

In particular embodiments, an edge 206 between a user node 202 and a concept node 204 may represent a particular action or activity performed by a user associated with user node 202 toward a concept associated with a concept node 204. As an example and not by way of limitation, as illustrated in FIG. 2, a user may “like,” “attended,” “played,” “listened,” “cooked,” “worked at,” or “watched” a concept, each of which may correspond to an edge type or subtype. A concept-profile interface corresponding to a concept node 204 may include, for example, a selectable “check in” icon (such as, for example, a clickable “check in” icon) or a selectable “add to favorites” icon. Similarly, after a user clicks these icons, the social-networking system 160 may create a “favorite” edge or a “check in” edge in response to a user's action corresponding to a respective action. As another example and not by way of limitation, a user (user “C”) may listen to a particular song (“Imagine”) using a particular application (SPOTIFY, which is an online music application). In this case, the social-networking system 160 may create a “listened” edge 206 and a “used” edge (as illustrated in FIG. 2) between user nodes 202 corresponding to the user and concept nodes 204 corresponding to the song and application to indicate that the user listened to the song and used the application. Moreover, the social-networking system 160 may create a “played” edge 206 (as illustrated in FIG. 2) between concept nodes 204 corresponding to the song and the application to indicate that the particular song was played by the particular application. In this case, “played” edge 206 corresponds to an action performed by an external application (SPOTIFY) on an external audio file (the song “Imagine”). Although this disclosure describes particular edges 206 with particular attributes connecting user nodes 202 and concept nodes 204, this disclosure contemplates any suitable edges 206 with any suitable attributes connecting user nodes 202 and concept nodes 204. Moreover, although this disclosure describes edges between a user node 202 and a concept node 204 representing a single relationship, this disclosure contemplates edges between a user node 202 and a concept node 204 representing one or more relationships. As an example and not by way of limitation, an edge 206 may represent both that a user likes and has used at a particular concept. Alternatively, another edge 206 may represent each type of relationship (or multiples of a single relationship) between a user node 202 and a concept node 204 (as illustrated in FIG. 2 between user node 202 for user “E” and concept node 204 for “SPOTIFY”).

In particular embodiments, the social-networking system 160 may create an edge 206 between a user node 202 and a concept node 204 in the social graph 200. As an example and not by way of limitation, a user viewing a concept-profile interface (such as, for example, by using a web browser or a special-purpose application hosted by the user's client system 130) may indicate that he or she likes the concept represented by the concept node 204 by clicking or selecting a “Like” icon, which may cause the user's client system 130 to send to the social-networking system 160 a message indicating the user's liking of the concept associated with the concept-profile interface. In response to the message, the social-networking system 160 may create an edge 206 between user node 202 associated with the user and concept node 204, as illustrated by “like” edge 206 between the user and concept node 204. In particular embodiments, the social-networking system 160 may store an edge 206 in one or more data stores. In particular embodiments, an edge 206 may be automatically formed by the social-networking system 160 in response to a particular user action. As an example and not by way of limitation, if a first user uploads a picture, watches a movie, or listens to a song, an edge 206 may be formed between user node 202 corresponding to the first user and concept nodes 204 corresponding to those concepts. Although this disclosure describes forming particular edges 206 in particular manners, this disclosure contemplates forming any suitable edges 206 in any suitable manner.

### Search Queries on Online Social Networks

In particular embodiments, the social-networking system 160 may receive, from a client system of a user of an online social network, a query inputted by the user. The user may submit the query to the social-networking system 160 by, for example, selecting a query input or inputting text into query field. A user of an online social network may search for information relating to a specific subject matter (e.g., users, concepts, external content or resource) by providing a short phrase describing the subject matter, often referred to as a “search query,” to a search engine. The query may be an unstructured text query and may comprise one or more text strings (which may include one or more n-grams). In general, a user may input any character string into a query field to search for content on the social-networking system 160 that matches the text query. The social-networking system 160 may then search a data store 164 (or, in particular, a social-graph database) to identify content matching the query. The search engine may conduct a search based on the query phrase using various search algorithms and generate search results that identify resources or content (e.g., user-profile interfaces, content-profile interfaces, or external resources) that are most likely to be related to the search query. To conduct a search, a user may input or send a search query to the search engine. In response, the search engine may identify one or more resources that are likely to be related to the search query, each of which may individually be referred to as a “search result,” or collectively be referred to as the “search results” corresponding to the search query. The identified content may include, for example, social-graph elements (i.e., user nodes 202, concept nodes 204, edges 206), profile interfaces, external web interfaces, or any combination thereof. The social-networking system 160 may then generate a search-results interface with search results corresponding to the identified content and send the search-results interface to the user. The search results may be presented to the user, often in the form of a list of links on the search-results interface, each link being associated with a different interface that contains some of the identified resources or content. In particular embodiments, each link in the search results may be in the form of a Uniform Resource Locator (URL) that specifies where the corresponding interface is located and the mechanism for retrieving it. The social-networking system 160 may then send the search-results interface to the web browser 132 on the user's client system 130. The user may then click on the URL links or otherwise select the content from the search-results interface to access the content from the social-networking system 160 or from an external system (such as, for example, a third-party system 170), as appropriate. The resources may be ranked and presented to the user according to their relative degrees of relevance to the search query. The search results may also be ranked and presented to the user according to their relative degree of relevance to the user. In other words, the search results may be personalized for the querying user based on, for example, social-graph information, user information, search or browsing history of the user, or other suitable information related to the user. In particular embodiments, ranking of the resources may be determined by a ranking algorithm implemented by the search engine. As an example and not by way of limitation, resources that are more relevant to the search query or to the user may be ranked higher than the resources that are less relevant to the search query or the user. In particular embodiments, the search engine may limit its search to resources and content on the online social network. However, in particular embodiments, the search engine may also search for resources or contents on other sources, such as a third-party system 170, the internet or World Wide Web, or other suitable sources. Although this disclosure describes querying the social-networking system 160 in a particular manner, this disclosure contemplates querying the social-networking system 160 in any suitable manner.

Typeahead Processes and Queries

In particular embodiments, one or more client-side and/or backend (server-side) processes may implement and utilize a “typeahead” feature that may automatically attempt to match social-graph elements (e.g., user nodes 202, concept nodes 204, or edges 206) to information currently being entered by a user in an input form rendered in conjunction with a requested interface (such as, for example, a user-profile interface, a concept-profile interface, a search-results interface, a user interface/view state of a native application associated with the online social network, or another suitable interface of the online social network), which may be hosted by or accessible in the social-networking system 160. In particular embodiments, as a user is entering text to make a declaration, the typeahead feature may attempt to match the string of textual characters being entered in the declaration to strings of characters (e.g., names, descriptions) corresponding to users, concepts, or edges and their corresponding elements in the social graph 200. In particular embodiments, when a match is found, the typeahead feature may automatically populate the form with a reference to the social-graph element (such as, for example, the node name/type, node ID, edge name/type, edge ID, or another suitable reference or identifier) of the existing social-graph element. In particular embodiments, as the user enters characters into a form box, the typeahead process may read the string of entered textual characters. As each keystroke is made, the frontend-typeahead process may send the entered character string as a request (or call) to the backend-typeahead process executing within the social-networking system 160. In particular embodiments, the typeahead process may use one or more matching algorithms to attempt to identify matching social-graph elements. In particular embodiments, when a match or matches are found, the typeahead process may send a response to the user's client system 130 that may include, for example, the names (name strings) or descriptions of the matching social-graph elements as well as, potentially, other metadata associated with the matching social-graph elements. As an example and not by way of limitation, if a user enters the characters “pok” into a query field, the typeahead process may display a drop-down menu that displays names of matching existing profile interfaces and respective user nodes 202 or concept nodes 204, such as a profile interface named or devoted to “poker” or “pokemon,” which the user can then click on or otherwise select thereby confirming the desire to declare the matched user or concept name corresponding to the selected node.

More information on typeahead processes may be found in U.S. patent application Ser. No. 12/763162, filed 19 Apr. 2010, and U.S. patent application Ser. No. 13/556072, filed 23 Jul. 2012, which are incorporated by reference.

In particular embodiments, the typeahead processes described herein may be applied to search queries entered by a user. As an example and not by way of limitation, as a user enters text characters into a query field, a typeahead process may attempt to identify one or more user nodes 202, concept nodes 204, or edges 206 that match the string of characters entered into the query field as the user is entering the characters. As the typeahead process receives requests or calls including a string or n-gram from the text query, the typeahead process may perform or cause to be performed a search to identify existing social-graph elements (i.e., user nodes 202, concept nodes 204, edges 206) having respective names, types, categories, or other identifiers matching the entered text. The typeahead process may use one or more matching algorithms to attempt to identify matching nodes or edges. When a match or matches are found, the typeahead process may send a response to the user's client system 130 that may include, for example, the names (name strings) of the matching nodes as well as, potentially, other metadata associated with the matching nodes. The typeahead process may then display a drop-down menu that displays names of matching existing profile interfaces and respective user nodes 202 or concept nodes 204, and displays names of matching edges 206 that may connect to the matching user nodes 202 or concept nodes 204, which the user can then click on or otherwise select thereby confirming the desire to search for the matched user or concept name corresponding to the selected node, or to search for users or concepts connected to the matched users or concepts by the matching edges. Alternatively, the typeahead process may simply auto-populate the form with the name or other identifier of the top-ranked match rather than display a drop-down menu. The user may then confirm the auto-populated declaration simply by keying “enter” on a keyboard or by clicking on the auto-populated declaration. Upon user confirmation of the matching nodes and edges, the typeahead process may send a request that informs the social-networking system 160 of the user's confirmation of a query containing the matching social-graph elements. In response to the request sent, the social-networking system 160 may automatically (or alternately based on an instruction in the request) call or otherwise search a social-graph database for the matching social-graph elements, or for social-graph elements connected to the matching social-graph elements as appropriate. Although this disclosure describes applying the typeahead processes to search queries in a particular manner, this disclosure contemplates applying the typeahead processes to search queries in any suitable manner.

In connection with search queries and search results, particular embodiments may utilize one or more systems, components, elements, functions, methods, operations, or steps disclosed in U.S. patent application Ser. No. 11/503093, filed 11 Aug. 2006, U.S. patent application Ser. No. 12/977027, filed 22 Dec. 2010, and U.S. patent application Ser. No. 12/978265, filed 23 Dec. 2010, which are incorporated by reference.

Structured Search Queries

In particular embodiments, in response to a text query received from a first user (i.e., the querying user), the social-networking system 160 may parse the text query and identify portions of the text query that correspond to particular social-graph elements. However, in some cases a query may include one or more terms that are ambiguous, where an ambiguous term is a term that may possibly correspond to multiple social-graph elements. To parse the ambiguous term, the social-networking system 160 may access a social graph 200 and then parse the text query to identify the social-graph elements that corresponded to ambiguous n-grams from the text query. The social-networking system 160 may then generate a set of structured queries, where each structured query corresponds to one of the possible matching social-graph elements. These structured queries may be based on strings generated by a grammar model, such that they are rendered in a natural-language syntax with references to the relevant social-graph elements. As an example and not by way of limitation, in response to the text query, “show me friends of my girlfriend,” the social-networking system 160 may generate a structured query “Friends of Stephanie,” where “Friends” and “Stephanie” in the structured query are references corresponding to particular social-graph elements. The reference to “Stephanie” would correspond to a particular user node 202 (where the social-networking system 160 has parsed the n-gram “my girlfriend” to correspond with a user node 202 for the user “Stephanie”), while the reference to “Friends” would correspond to friend-type edges 206 connecting that user node 202 to other user nodes 202 (i.e., edges 206 connecting to “Stephanie's” first-degree friends). When executing this structured query, the social-networking system 160 may identify one or more user nodes 202 connected by friend-type edges 206 to the user node 202 corresponding to “Stephanie”. As another example and not by way of limitation, in response to the text query, “friends who work at facebook,” the social-networking system 160 may generate a structured query “My friends who work at Facebook,” where “my friends,” “work at,” and “Facebook” in the structured query are references corresponding to particular social-graph elements as described previously (i.e., a friend-type edge 206, a work-at-type edge 206, and concept node 204 corresponding to the company “Facebook”). By providing suggested structured queries in response to a user's text query, the social-networking system 160 may provide a powerful way for users of the online social network to search for elements represented in the social graph 200 based on their social-graph attributes and their relation to various social-graph elements. Structured queries may allow a querying user to search for content that is connected to particular users or concepts in the social graph 200 by particular edge-types. The structured queries may be sent to the first user and displayed in a drop-down menu (via, for example, a client-side typeahead process), where the first user can then select an appropriate query to search for the desired content. Some of the advantages of using the structured queries described herein include finding users of the online social network based upon limited information, bringing together virtual indexes of content from the online social network based on the relation of that content to various social-graph elements, or finding content related to you and/or your friends. Although this disclosure describes generating particular structured queries in a particular manner, this disclosure contemplates generating any suitable structured queries in any suitable manner.

More information on element detection and parsing queries may be found in U.S. patent application Ser. No. 13/556072, filed 23 Jul. 2012, U.S. patent application Ser. No. 13/731866, filed 31 Dec. 2012, and U.S. patent application Ser. No. 13/732101, filed 31 Dec. 2012, each of which is incorporated by reference. More information on structured search queries and grammar models may be found in U.S. patent application Ser. No. 13/556072, filed 23 Jul. 2012, U.S. patent application Ser. No. 13/674695, filed 12 Nov. 2012, and U.S. patent application Ser. No. 13/731866, filed 31 Dec. 2012, each of which is incorporated by reference.

Generating Keywords and Keyword Queries

In particular embodiments, the social-networking system 160 may provide customized keyword completion suggestions to a querying user as the user is inputting a text string into a query field. Keyword completion suggestions may be provided to the user in a non-structured format. In order to generate a keyword completion suggestion, the social-networking system 160 may access multiple sources within the social-networking system 160 to generate keyword completion suggestions, score the keyword completion suggestions from the multiple sources, and then return the keyword completion suggestions to the user. As an example and not by way of limitation, if a user types the query “friends stan,” then the social-networking system 160 may suggest, for example, “friends stanford,” “friends stanford university,” “friends stanley,” “friends stanley cooper,” “friends stanley kubrick,” “friends stanley cup,” and “friends stanlonski.” In this example, the social-networking system 160 is suggesting the keywords which are modifications of the ambiguous n-gram “stan,” where the suggestions may be generated from a variety of keyword generators. The social-networking system 160 may have selected the keyword completion suggestions because the user is connected in some way to the suggestions. As an example and not by way of limitation, the querying user may be connected within the social graph 200 to the concept node 204 corresponding to Stanford University, for example by like- or attended-type edges 206. The querying user may also have a friend named Stanley Cooper. Although this disclosure describes generating keyword completion suggestions in a particular manner, this disclosure contemplates generating keyword completion suggestions in any suitable manner.

More information on keyword queries may be found in U.S. U.S. patent application Ser. No. 14/244748, filed 3 Apr. 2014, U.S. patent application Ser. No. 14/470607, filed 27 Aug. 2014, and U.S. patent application Ser. No. 14/561418, filed 5 Dec. 2014, each of which is incorporated by reference.

### Indexing Based on Object-Type

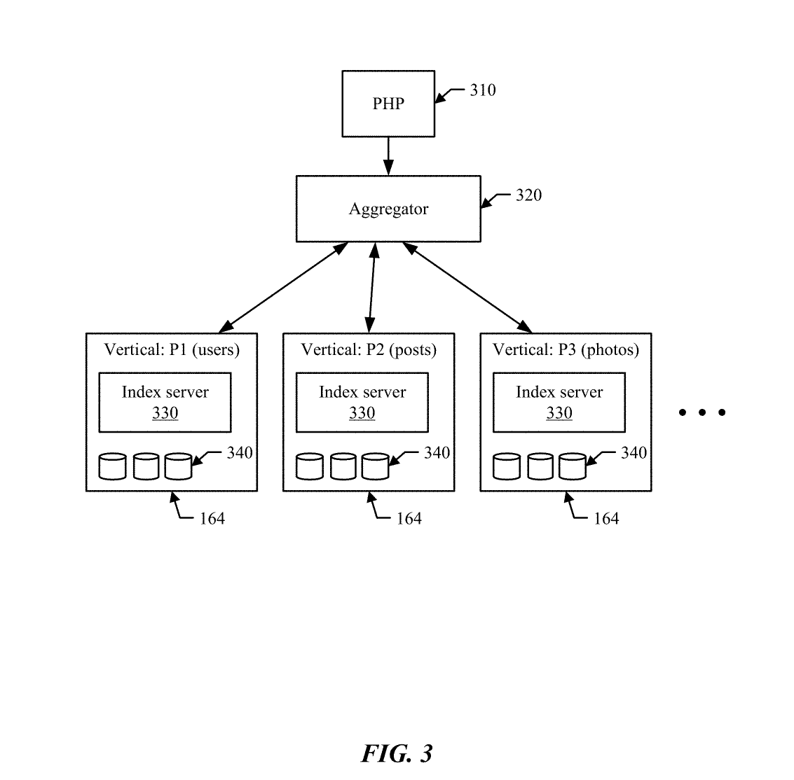

FIG. 3 illustrates an example partitioning for storing objects of a social-networking system 160. A plurality of data stores 164 (which may also be called “verticals”) may store objects of social-networking system 160. The amount of data (e.g., data for a social graph 200) stored in the data stores may be very large. As an example and not by way of limitation, a social graph used by Facebook, Inc. of Menlo Park, Calif. can have a number of nodes in the order of 10⁸, and a number of edges in the order of 10¹⁰. Typically, a large collection of data such as a large database may be divided into a number of partitions. As the index for each partition of a database is smaller than the index for the overall database, the partitioning may improve performance in accessing the database. As the partitions may be distributed over a large number of servers, the partitioning may also improve performance and reliability in accessing the database. Ordinarily, a database may be partitioned by storing rows (or columns) of the database separately. In particular embodiments, a database maybe partitioned based on object-types. Data objects may be stored in a plurality of partitions, each partition holding data objects of a single object-type. In particular embodiments, social-networking system 160 may retrieve search results in response to a search query by submitting the search query to a particular partition storing objects of the same object-type as the search query's expected results. Although this disclosure describes storing objects in a particular manner, this disclosure contemplates storing objects in any suitable manner.

In particular embodiments, each object may correspond to a particular node of a social graph 200. An edge 206 connecting the particular node and another node may indicate a relationship between objects corresponding to these nodes. In addition to storing objects, a particular data store may also store social-graph information relating to the object. Alternatively, social-graph information about particular objects may be stored in a different data store from the objects. Social-networking system 160 may update the search index of the data store based on newly received objects, and relationships associated with the received objects.

In particular embodiments, each data store 164 may be configured to store objects of a particular one of a plurality of object-types in respective data storage devices 340. An object-type may be, for example, a user, a photo, a post, a comment, a message, an event listing, a web interface, an application, a location, a user-profile interface, a concept-profile interface, a user group, an audio file, a video, an offer/coupon, or another suitable type of object. Although this disclosure describes particular types of objects, this disclosure contemplates any suitable types of objects. As an example and not by way of limitation, a user vertical P1 illustrated in FIG. 3 may store user objects. Each user object stored in the user vertical P1 may comprise an identifier (e.g., a character string), a user name, and a profile picture for a user of the online social network. Social-networking system 160 may also store in the user vertical P1 information associated with a user object such as language, location, education, contact information, interests, relationship status, a list of friends/contacts, a list of family members, privacy settings, and so on. As an example and not by way of limitation, a post vertical P2 illustrated in FIG. 3 may store post objects. Each post object stored in the post vertical P2 may comprise an identifier, a text string for a post posted to social-networking system 160. Social-networking system 160 may also store in the post vertical P2 information associated with a post object such as a time stamp, an author, privacy settings, users who like the post, a count of likes, comments, a count of comments, location, and so on. As an example and not by way of limitation, a photo vertical P3 may store photo objects (or objects of other media types such as video or audio). Each photo object stored in the photo vertical P3 may comprise an identifier and a photo. Social-networking system 160 may also store in the photo vertical P3 information associated with a photo object such as a time stamp, an author, privacy settings, users who are tagged in the photo, users who like the photo, comments, and so on. In particular embodiments, each data store may also be configured to store information associated with each stored object in data storage devices 340.

In particular embodiments, objects stored in each vertical 164 may be indexed by one or more search indices. The search indices may be hosted by respective index server 330 comprising one or more computing devices (e.g., servers). The index server 330 may update the search indices based on data (e.g., a photo and information associated with a photo) submitted to social-networking system 160 by users or other processes of social-networking system 160 (or a third-party system). The index server 330 may also update the search indices periodically (e.g., every 24 hours). The index server 330 may receive a query comprising a search term, and access and retrieve search results from one or more search indices corresponding to the search term. In some embodiments, a vertical corresponding to a particular object-type may comprise a plurality of physical or logical partitions, each comprising respective search indices.

In particular embodiments, social-networking system 160 may receive a search query from a PHP (Hypertext Preprocessor) process 310. The PHP process 310 may comprise one or more computing processes hosted by one or more servers 162 of social-networking system 160. The search query may be a text string or a search query submitted to the PHP process by a user or another process of social-networking system 160 (or third-party system 170). In particular embodiments, an aggregator 320 may be configured to receive the search query from PHP process 310 and distribute the search query to each vertical. The aggregator may comprise one or more computing processes (or programs) hosted by one or more computing devices (e.g. servers) of the social-networking system 160. Particular embodiments may maintain the plurality of verticals 164 as illustrated in FIG. 3. Each of the verticals 164 may be configured to store a single type of object indexed by a search index as described earlier. In particular embodiments, the aggregator 320 may receive a search request. For example, the aggregator 320 may receive a search request from a PHP (Hypertext Preprocessor) process 210 illustrated in FIG. 2. In particular embodiments, the search request may comprise a text string. The search request may be a structured or substantially unstructured text string submitted by a user via a PHP process. The search request may also be structured or a substantially unstructured text string received from another process of the social-networking system. In particular embodiments, the aggregator 320 may determine one or more search queries based on the received search request. In particular embodiments, each of the search queries may have a single object type for its expected results (i.e., a single result-type). In particular embodiments, the aggregator 320 may, for each of the search queries, access and retrieve search query results from at least one of the verticals 164, wherein the at least one vertical 164 is configured to store objects of the object type of the search query (i.e., the result-type of the search query). In particular embodiments, the aggregator 320 may aggregate search query results of the respective search queries. For example, the aggregator 320 may submit a search query to a particular vertical and access index server 330 of the vertical, causing index server 330 to return results for the search query.

More information on indexes and search queries may be found in U.S. patent application Ser. No. 13/560212, filed 27 Jul. 2012, U.S. patent application Ser. No. 13/560901, filed 27 Jul. 2012, U.S. patent application Ser. No. 13/723861, filed 21 Dec. 2012, and U.S. patent application Ser. No. 13/870113, filed 25 Apr. 2013, each of which is incorporated by reference.

### Vector Spaces and Embeddings

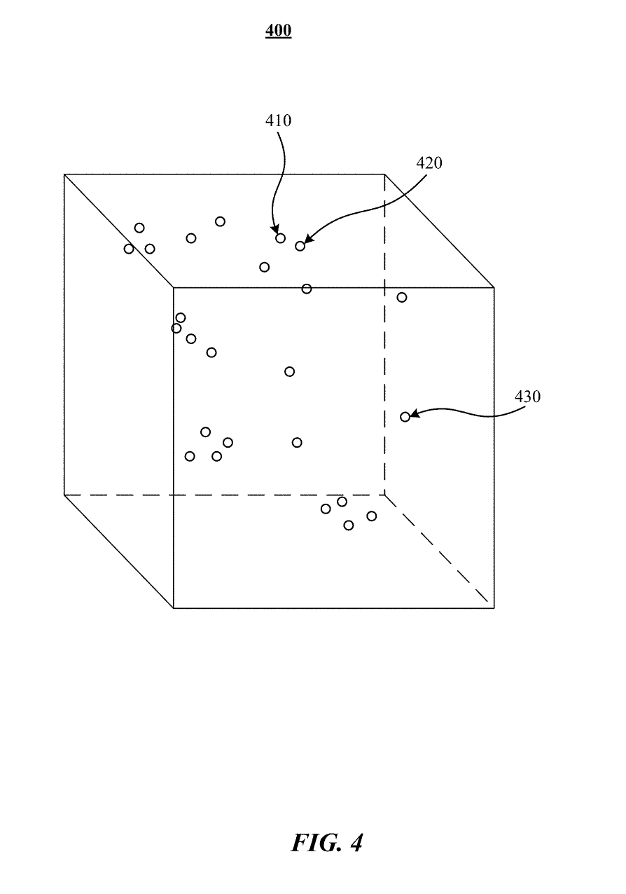

FIG. 4 illustrates an example view of a vector space 400. In particular embodiments, an object or an n-gram may be represented in a d-dimensional vector space, where d denotes any suitable number of dimensions. Although the vector space 400 is illustrated as a three-dimensional space, this is for illustrative purposes only, as the vector space 400 may be of any suitable dimension. In particular embodiments, an n-gram may be represented in the vector space 400 as a vector referred to as a term embedding. Each vector may comprise coordinates corresponding to a particular point in the vector space 400 (i.e., the terminal point of the vector). As an example and not by way of limitation, vectors 410, 420, and 430 may be represented as points in the vector space 400, as illustrated in FIG. 4. An n-gram may be mapped to a respective vector representation. As an example and not by way of limitation, n-grams t₁ and t₂ may be mapped to vectors [symbol] and [symbol] in the vector space 400, respectively, by applying a function [symbol] defined by a dictionary, such that [symbol] = [symbol] (t₁) and [symbol] = [symbol] (t₂). As another example and not by way of limitation, a dictionary trained to map text to a vector representation may be utilized, or such a dictionary may be itself generated via training. As another example and not by way of limitation, a model, such as Word2vec, may be used to map an n-gram to a vector representation in the vector space 400. In particular embodiments, an n-gram may be mapped to a vector representation in the vector space 400 by using a machine leaning model (e.g., a neural network). The machine learning model may have been trained using a sequence of training data (e.g., a corpus of objects each comprising n-grams).

In particular embodiments, an object may be represented in the vector space 400 as a vector referred to as a feature vector or an object embedding. As an example and not by way of limitation, objects e₁ and e₂ may be mapped to vectors [symbol] and [symbol] in the vector space 400, respectively, by applying a function [symbol] , such that [symbol] = [symbol] (e₁) and [symbol] = [symbol] (e₂). In particular embodiments, an object may be mapped to a vector based on one or more properties, attributes, or features of the object, relationships of the object with other objects, or any other suitable information associated with the object. As an example and not by way of limitation, a function [symbol] may map objects to vectors by feature extraction, which may start from an initial set of measured data and build derived values (e.g., features). As an example and not by way of limitation, an object comprising a video or an image may be mapped to a vector by using an algorithm to detect or isolate various desired portions or shapes of the object. Features used to calculate the vector may be based on information obtained from edge detection, corner detection, blob detection, ridge detection, scale-invariant feature transformation, edge direction, changing intensity, autocorrelation, motion detection, optical flow, thresholding, blob extraction, template matching, Hough transformation (e.g., lines, circles, ellipses, arbitrary shapes), or any other suitable information. As another example and not by way of limitation, an object comprising audio data may be mapped to a vector based on features such as a spectral slope, a tonality coefficient, an audio spectrum centroid, an audio spectrum envelope, a Mel-frequency cepstrum, or any other suitable information. In particular embodiments, when an object has data that is either too large to be efficiently processed or comprises redundant data, a function [symbol] may map the object to a vector using a transformed reduced set of features (e.g., feature selection). In particular embodiments, a function [symbol] may map an object e to a vector [symbol] (e) based on one or more n-grams associated with object e. Although this disclosure describes representing an n-gram or an object in a vector space in a particular manner, this disclosure contemplates representing an n-gram or an object in a vector space in any suitable manner.

In particular embodiments, the social-networking system 160 may calculate a similarity metric of vectors in vector space 400. A similarity metric may be a cosine similarity, a Minkowski distance, a Mahalanobis distance, a Jaccard similarity coefficient, or any suitable similarity metric. As an example and not by way of limitation, a similarity metric of [symbol] and [symbol] may be a cosine similarity

$$\frac{\vec{{v}_{1}} \cdot \vec{{v}_{2}}}{‖ \vec{{v}_{1}} ‖ ‖ \vec{{v}_{2}} ‖} .$$

As another example and not by way of limitation, a similarity metric of [symbol] and [symbol] may be a Euclidean distance ∥ [symbol] - [symbol] ∥. A similarity metric of two vectors may represent how similar the two objects or n-grams corresponding to the two vectors, respectively, are to one another, as measured by the distance between the two vectors in the vector space 400. As an example and not by way of limitation, vector 410 and vector 420 may correspond to objects that are more similar to one another than the objects corresponding to vector 410 and vector 430, based on the distance between the respective vectors. Although this disclosure describes calculating a similarity metric between vectors in a particular manner, this disclosure contemplates calculating a similarity metric between vectors in any suitable manner.

More information on vector spaces, embeddings, feature vectors, and similarity metrics may be found in U.S. patent application Ser. No. 14/949436, filed 23 Nov. 2015, U.S. patent application Ser. No. 15/286315, filed 5 Oct. 2016, and U.S. patent application Ser. No. 15/365789, filed 30 Nov. 2016, each of which is incorporated by reference.

### Artificial Neural Networks

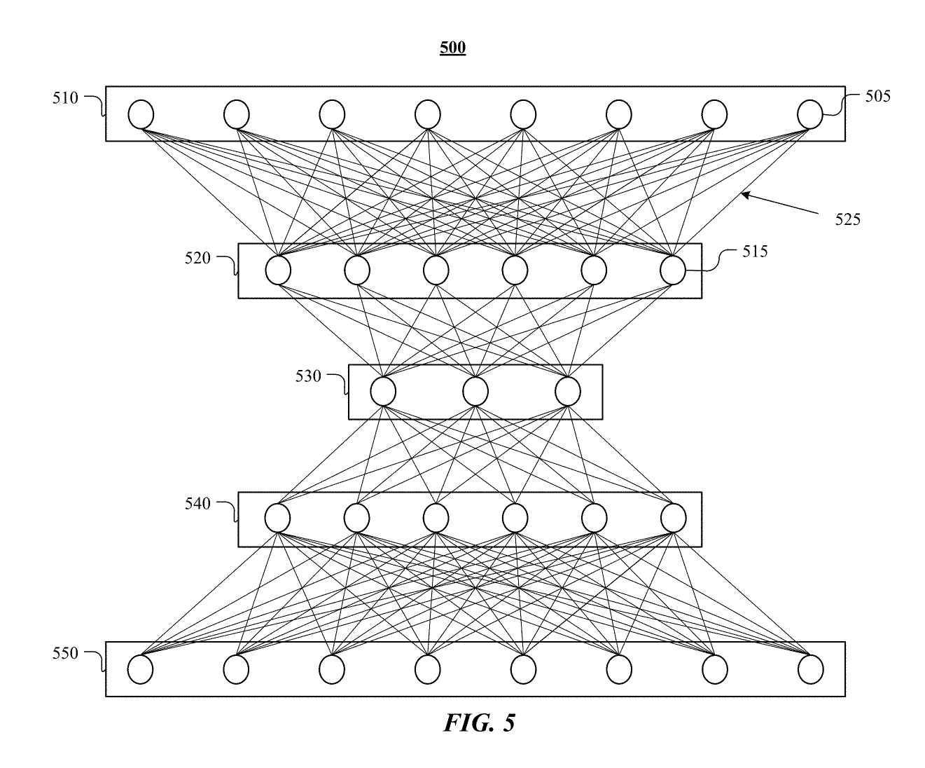

FIG. 5 illustrates an example artificial neural network (“ANN”) 500. In particular embodiments, an ANN may refer to a computational model comprising one or more nodes. Example ANN 500 may comprise an input layer 510, hidden layers 520, 530, 540, and an output layer 550. Each layer of the ANN 500 may comprise one or more nodes, such as a node 505 or a node 515. In particular embodiments, each node of an ANN may be connected to another node of the ANN. As an example and not by way of limitation, each node of the input layer 510 may be connected to one of more nodes of the hidden layer 520. In particular embodiments, one or more nodes may be a bias node (e.g., a node in a layer that is not connected to and does not receive input from any node in a previous layer). In particular embodiments, each node in each layer may be connected to one or more nodes of a previous or subsequent layer. Although FIG. 5 depicts a particular ANN with a particular number of layers, a particular number of nodes, and particular connections between nodes, this disclosure contemplates any suitable ANN with any suitable number of layers, any suitable number of nodes, and any suitable connections between nodes. As an example and not by way of limitation, although FIG. 5 depicts a connection between each node of the input layer 510 and each node of the hidden layer 520, one or more nodes of the input layer 510 may not be connected to one or more nodes of the hidden layer 520.

In particular embodiments, an ANN may be a feedforward ANN (e.g., an ANN with no cycles or loops where communication between nodes flows in one direction beginning with the input layer and proceeding to successive layers). As an example and not by way of limitation, the input to each node of the hidden layer 520 may comprise the output of one or more nodes of the input layer 510. As another example and not by way of limitation, the input to each node of the output layer 550 may comprise the output of one or more nodes of the hidden layer 540. In particular embodiments, an ANN may be a deep neural network (e.g., a neural network comprising at least two hidden layers). In particular embodiments, an ANN may be a deep residual network. A deep residual network may be a feedforward ANN comprising hidden layers organized into residual blocks. The input into each residual block after the first residual block may be a function of the output of the previous residual block and the input of the previous residual block. As an example and not by way of limitation, the input into residual block N may be F(x)+x, where F(x) may be the output of residual block N−1, x may be the input into residual block N−1. Although this disclosure describes a particular ANN, this disclosure contemplates any suitable ANN.

In particular embodiments, an activation function may correspond to each node of an ANN. An activation function of a node may define the output of a node for a given input. In particular embodiments, an input to a node may comprise a set of inputs. As an example and not by way of limitation, an activation function may be an identity function, a binary step function, a logistic function, or any other suitable function. As another example and not by way of limitation, an activation function for a node k may be the sigmoid function

$${F}_{k} ( {s}_{k} ) = \frac{1}{1 + {e}^{- {s}_{k}}} ,$$

the hyperbolic tangent function

$${F}_{k} ( {s}_{k} ) = \frac{{e}^{{s}_{k }} - {e}^{- {s}_{k}}}{{e}^{{s}_{k }} + {e}^{- {s}_{k}}} ,$$

the rectifier Fₖ(sₖ)=max(0, sₖ), or any other suitable function Fₖ(sₖ), where sₖ may be the effective input to node k. In particular embodiments, the input of an activation function corresponding to a node may be weighted. Each node may generate output using a corresponding activation function based on weighted inputs. In particular embodiments, each connection between nodes may be associated with a weight. As an example and not by way of limitation, a connection 525 between the node 505 and the node 515 may have a weighting coefficient of 0.4, which may indicate that 0.4 multiplied by the output of the node 505 is used as an input to the node 515. As another example and not by way of limitation, the output yₖ of node k may be yₖ=Fₖ(sₖ), where Fₖ may be the activation function corresponding to node k, sₖ=Σⱼ(wⱼₖxⱼ) may be the effective input to node k, xⱼ may be the output of a node j connected to node k, and wⱼₖ may be the weighting coefficient between node j and node k. In particular embodiments, the input to nodes of the input layer may be based on a vector representing an object. Although this disclosure describes particular inputs to and outputs of nodes, this disclosure contemplates any suitable inputs to and outputs of nodes. Moreover, although this disclosure may describe particular connections and weights between nodes, this disclosure contemplates any suitable connections and weights between nodes.

In particular embodiments, an ANN may be trained using training data. As an example and not by way of limitation, training data may comprise inputs to the ANN500 and an expected output. As another example and not by way of limitation, training data may comprise vectors each representing a training object and an expected label for each training object. In particular embodiments, training an ANN may comprise modifying the weights associated with the connections between nodes of the ANN by optimizing an objective function. As an example and not by way of limitation, a training method may be used (e.g., the conjugate gradient method, the gradient descent method, the stochastic gradient descent) to backpropagate the sum-of-squares error measured as a distances between each vector representing a training object (e.g., using a cost function that minimizes the sum-of-squares error). In particular embodiments, an ANN may be trained using a dropout technique. As an example and not by way of limitation, one or more nodes may be temporarily omitted (e.g., receive no input and generate no output) while training. For each training object, one or more nodes of the ANN may have some probability of being omitted. The nodes that are omitted for a particular training object may be different than the nodes omitted for other training objects (e.g., the nodes may be temporarily omitted on an object-by-object basis). Although this disclosure describes training an ANN in a particular manner, this disclosure contemplates training an ANN in any suitable manner.

### Searching Using Entity-Based Embeddings

In particular embodiments, the social-networking system 160 may generate embeddings for entities, such as pages, groups, and users, in the same embedding space as term embeddings based on an entity embedding model. The entity embedding model may be an extension of a paragraph2vector model introduced in Q. Le and T. Mikolov [Ref. 1] to cover generating embeddings for entities in an online social network, and thus may be thought of as an “entity2vector” model. The entity embeddings may be used in search ranking, entity disambiguation, intent classification, group search, typeahead, and other suitable applications. Users of the online social network may search for various entities in the online social network including pages, groups, and users, with a short query term string. Word embeddings have been used to process such query requests. However, an entity (e.g., a page) usually comprises a large number of terms. Thus, processing a search request based on word embeddings may be computationally expensive. Entity embeddings may provide a computationally less expensive alternative solution for processing search queries for entities in the online social network. The entity embeddings may be useful in computing the similarity of a query to an entity, computing nearest neighbors to an entity, and discovering terms or entities (e.g., pages, groups, or users) within a certain distance from the given query or entity within an embedding space. Based on a large corpus of training data, a term embedding matrix (also known as a term embedding table) may be created. The term embedding matrix may comprise unigrams and selected n-grams. Entity embeddings may be generated by a backpropagation technique with the given term embedding matrix to form an entity embedding matrix (also known as an entity embedding table). Not all entities may comprise enough content. A page may have only few words, which may not be enough to properly represent the page. The social-networking system 160 may use entity embedding inference techniques to generate an embedding for the page. As an example and not by way of limitation, the official page of Manchester United (MU), the English Premier League football team, may be a relatively inactive page, with few posts and therefore little text to analyze. To generate an embedding for the official page of MU, the system may infer an embedding based on more active co-visited entities, such as Ryan Giggs (a former MU player) and Paul Pogba (a current MU player). When the social-networking system 160 receives a query “Manchester United,” the social-networking system 160 may generate a query embedding for the given query and find entities that have corresponding entity embeddings similar to the query embedding. In response to the query for “Manchester United,” the pages for Giggs and Pogba along with the official page of the MU would be ranked high in the search results even though pages for Giggs and Pogba may not have a high text matching to the query. Processing queries based on entity embeddings may improve over simpler text matching systems that may have up-ranked pages with more terms matching the query (e.g., the page for the city of Manchester), which may be a poor match for the intent of the query. Experiments shows that query processing based on entity embeddings outperformed the traditional query processing based on text matching by improving Mean Average Precision (MAP) by 38.5%. Entity embeddings may also improve query processing time because processing search results based on word embeddings may require more computing resources and processing time compared to the processing based on entity embeddings. Although this disclosure describes processing search queries based on entity embeddings in a particular manner, this disclosure contemplates processing search queries based on entity embeddings in any suitable manner.

In particular embodiments, the social-networking system 160 may receive a trigger to deploy a new version of the entity embeddings stored in the one or more production data stores. The trigger may be an expiration of a version update timer associated with the entity embeddings stored in the one or more production data stores. The social-networking system 160 may create a new term embedding matrix, each column of which corresponds to a unigram or a pre-identified bi-gram appearing in a corpus of text extracted from objects in the online social network. In order to create the new term embedding matrix, the social-networking system 160 may prepare an initialized term embedding matrix on one or more temporary data stores. The one or more temporary data stores may be apart from the one or more production data stores. Each column of the initialized term embedding matrix corresponds to one of the unigram or the pre-identified bi-gram appearing in the corpus of text. The social-networking system 160 may train term embeddings in the initialized term embedding matrix using a term embedding model. The term embedding model may use a stochastic gradient descent process with a gradient obtained via backpropagation. The term embedding model may be a word2vec model. The social-networking system 160 may create, using term embeddings in the created term embedding matrix, a new entity embedding matrix, each column of which corresponds to an eligible entity in the online social network. An eligible entity is an entity that can be represented by an entity embedding. In order to create the new entity embedding matrix, the social-networking system 160 may identify eligible entities in the online social network from one or more verticals in the online social network. The social-networking system 160 may, for each eligible entity, select text to be used for generating an entity embedding corresponding to the entity. The selected text has a determined probability of being relevant to the entity greater than a threshold probability. The social-networking system 160 may determine, for each eligible entity, whether the selected text is sufficient to represent the entity. Such determination may be based on an amount of the selected text. The social-networking system 160 may add each eligible entity to a training entity pool if the selected text for the eligible entity is determined to be sufficient to represent the entity. The social-networking system 160 may add each eligible entity to an inference entity pool if the selected text for the eligible entity is determined not sufficient to represent the entity.

The social-networking system 160 may prepare an initialized entity embedding matrix, on one or more temporary data stores. Each column of the initialized entity embedding matrix corresponds to one of the entities in the training entity pool. The social-networking system 160 may train entity embeddings in the initialized entity embedding matrix using an entity embedding model that uses a stochastic gradient descent process with a gradient obtained via backpropagation. In particular embodiments, the entity embedding model may be a distributed memory model. With the distributed memory model, the social-networking system 160 may associate, for each entity in the training entity pool, an entity identifier for the entity and the corresponding initialized entity embedding in the initialized entity embedding matrix. The social-networking system 160 may retrieve, for each entity in the training entity pool, term embeddings corresponding to terms in the selected text from the term embedding matrix. The social-networking system 160 may iteratively train the initialized entity embedding matrix using the stochastic gradient descent process. In an iteration of the stochastic gradient descent process, the social-networking system 160 may sample, for each entity in the training entity pool, a term sequence of k terms from a sliding window over the selected text, where k is a fixed-length of the term sequence and the social-networking system 160 may perform a backpropagation process on a current iteration of the initialized entity embedding matrix in order to maximize, for each entity embedding in the entity embedding matrix, a probability that an embedding vector that is a combination of the entity embedding and term embeddings corresponding to the first k-1 terms of the sampled term sequence correctly predicts a k-th term in the term sequence. The combination of the entity embedding and term embeddings may comprise taking an average of the entity embedding and the term embeddings. In particular embodiments, the combination of the entity embedding and term embeddings may comprise concatenating the entity embedding with the term embeddings. In particular embodiments, the entity embedding model may be a distributed bag-of-words model. With the distributed bag-of-words model, the social-networking system 160 may associate, for each entity in the training entity pool, an entity identifier for the entity and the corresponding initialized entity embedding in the initialized entity embedding matrix. The social-networking system 160 may iteratively train the initialized entity embedding matrix using the stochastic gradient descent process. In each iteration of the stochastic gradient descent process, the social-networking system 160 may sample, for each entity in the training entity pool, a term sequence of k-terms from a sliding window over the selected text, where k is a fixed-length of the term sequence and the social-networking system 160 may perform a backpropagation process on a current iteration of the initialized entity embedding matrix in order to maximize, for each entity embedding in the entity embedding matrix, a probability that the entity embedding correctly predicts each term in the sampled term sequence.

In particular embodiments, after training entity embeddings for the eligible entities in the training entity pool, the social-networking system 160 may generate an entity embedding for each entity in the inference entity pool by performing an embedding interpolation. For the embedding interpolation, for each entity in the inference entity pool, the social-networking system 160 may identify one or more neighboring entities of the entity that have entity embeddings stored in the one or more temporary data stores from a social graph 200 of the online social network. The social-networking system 160 may determine a weight for each edge connecting the entity and each of the identified one or more neighboring entity. The weight for each edge may be proportional to the number of co-visits by users of the online social network to the entity and the identified neighboring entity. The weights may be normalized so that a sum of the weights is 1. The social-networking system 160 may generate an entity embedding corresponding to the entity by taking a weighted average of entity embeddings corresponding to the identified neighboring entities. If a first entity in the inference entity pool has no neighboring entities with an entity embedding stored in the one or more temporary data stores in the social graph 200 of the online social network, then the social-networking system 160 may, for the embedding interpolation for the first entity, determine a weight for each edge connecting two entities within a threshold degree of separation of the first entity in the social graph 200. The social-networking system 160 may calculate a number of recorded visits per entity using a repeated random walk with restart on the social graph 200 for a pre-determined number of random walks. For a random walk with restart procedure, the social-networking system 160 may set a node representing the first entity to a source node. The social-networking system 160 may perform a walk from the source node to a neighboring destination node in the social graph 200 of the online social network. Walking to the destination node makes the destination node a source node for a next walk. When more than one neighboring nodes are available from the source node, the neighboring destination node is randomly chosen based on the determined weights on the edges between the source node and the neighboring nodes. The social-networking system 160 may repeat the walks for a randomly chosen number of times and record, at the end of the walks for the randomly chosen number of times, a second entity represented by the destination node if the second entity has a corresponding entity embedding. After performing random walk with restart procedures for a pre-determined number of times, the social-networking system 160 may calculate, for each of the recorded second entities, a similarity of the first entity to the second entity based on a number of recorded visits to the second entity out of a total number of recorded visits. The social-networking system 160 may generate an entity embedding for the first entity by taking a weighted average of entity embeddings corresponding to the recorded second entities, where the applied weights in the weighted average are proportional to the calculated similarities, and the applied weights are normalized so that a sum of the weights is 1. Once the social-networking system 160 generates an entity embedding for an entity in the inference entity pool, the social-networking system 160 may add the generated entity embedding into the entity embedding matrix.

In particular embodiments, the social-networking system 160 may, once creating the new term embedding matrix and the new entity embedding matrix has completed, replace an existing term embedding matrix with the new term embedding matrix and an existing entity embedding matrix with the new entity embedding matrix on the one or more production data stores.

In particular embodiments, the social-networking system 160 may receive a search query for entities in an online social network from a client system associated with a user of the online social network, where entities comprise one or more of pages, groups, or users. The search query may comprise one or more n-grams. The social-networking system 160 may generate a query embedding corresponding to the search query using an entity embedding model. In order to generate the query embedding, the social-networking system 160 may parse the search query to identify one or more unique entities associated with the online social network referenced in the search query and generate one or more term embeddings representing the one or more n-grams of the search query, respectively, using a term embedding model. The query embedding represents the search query as a point in a d-dimensional embedding space. Each term embedding for an n-gram referencing one of the unique entities is a term embedding for the respective unique entity. The social-networking system 160 may generate, using the entity embedding model, a query embedding using the generated term embeddings corresponding to the search query. The social-networking system 160 may identify one or more entities in the online social networking matching the one or more n-grams of the search query. The social-networking system 160 may retrieve a plurality of entity embeddings corresponding to a plurality of entities, respectively, from one or more production data stores. Each entity embedding represents the corresponding entity as a point in the d-dimensional embedding space. The social-networking system 160 may calculate a similarity metric between the query embedding and the entity embedding for each of the retrieved entity embeddings. The similarity metric measures a degree of similarity of the query embedding to the entity embedding. The similarity metric may be a cosign similarity. The social-networking system 160 may rank the entities based on their respective calculated similarity metrics. The social-networking system 160 may send instructions for presenting a search-results interface to the client system in response to the search query. The search-results interface may comprise one or more search results corresponding to one or more of the entities, respectively, where the one or more search results may be presented in ranked order based on the rankings of their corresponding entities.

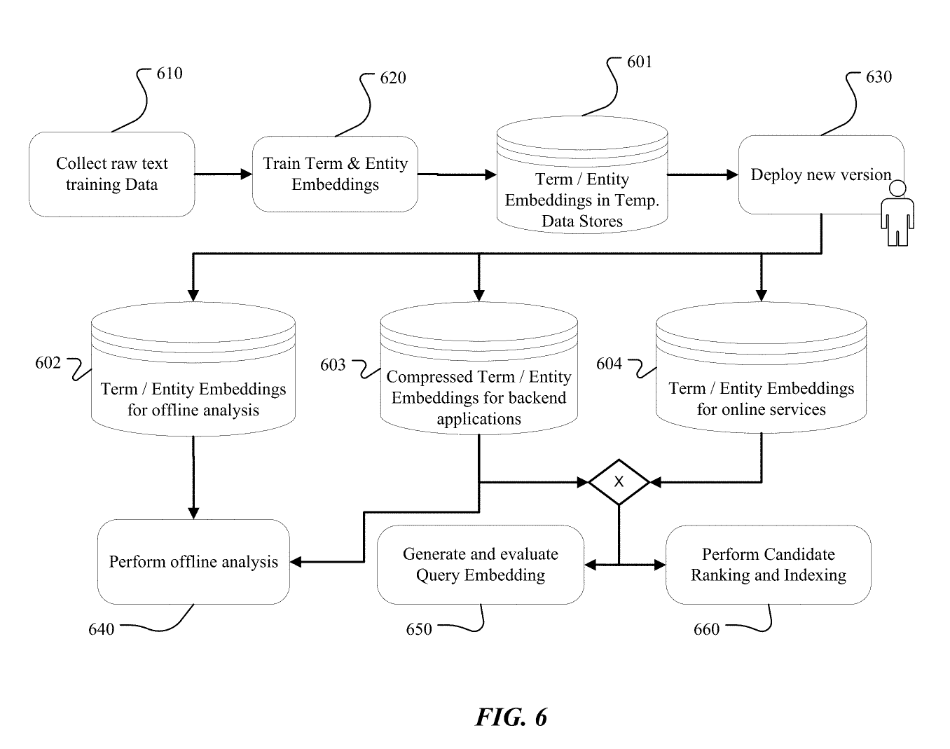

FIG. 6 illustrates an example process of deploying a new version of entity embeddings. In particular embodiments, the social-networking system 160 may receive a trigger to deploy a new version of the entity embeddings stored in the one or more production data stores. The social-networking system 160 may need to re-generate entity embeddings as public perception on an entity may change over time. For example, public perception on Golden State Warriors, an American professional basketball team, might have changed significantly after the team won the NBA championship in 2015 for the first time in 40 years since the 1975 championship. Also, the social-networking system 160 may also update term embeddings because significance and main usage of a term may change over time. As an example and not by way of limitation, the social-networking system 160 may receive a trigger to deploy a new version of entity embeddings. The trigger may be an expiration of a version update timer associated with the entity embeddings stored in the one or more production data stores. In particular embodiments, the trigger may be generated based on a determination that a new version of entity embeddings is needed. Such determination may be based on an observation that the measured performances of processes utilizing the entity embeddings does not meet the expectation. For example, a trigger to deploy a new version of entity embeddings stored in the one or more production data stores may be generated when the performance of search query processing using entity embeddings does not meet the expectation. Although this disclosure describes receiving a trigger to deploy a new version of the entity embeddings stored in the one or more production data stores in a particular manner, this disclosure contemplates receiving a trigger to deploy a new version of the entity embeddings stored in the one or more production data stores in any suitable manner.

In particular embodiments, the social-networking system 160 may, at step 610, collect raw text data from objects in the online social network created during a pre-determined period of time. The social-networking system 160 may identify a list of terms based on the collected raw text data from objects, where the identified term list comprises unique unigrams appearing in the corpus of text and a plurality of n-grams frequently appearing in the corpus of text. The social-networking system 160 may limit the n-grams to only unigrams and bi-grams for simplicity, or may also include tri-grams or larger n-grams. As an example and not by way of limitation, on receiving a trigger to deploy a new version of entity embeddings, the social-networking system 160 may collect raw text data from posts, photos, videos, user profile, and/or page descriptions that have been created during the last 6 months in the online social network. The social-networking system 160 may identify a list of unique unigrams appearing in the collected raw text and a plurality of bi-grams appearing frequently in the collected raw text. Although this disclosure describes collecting raw text from objects in the online social network in a particular manner, this disclosure contemplates collecting raw text from objects in the online social network in any suitable manner.

In particular embodiments, the social-networking system 160 may create a new term embedding matrix, each column of which corresponds to a unigram or a pre-identified bi-gram appearing in a corpus of text extracted from objects in the online social network. In order to create the new term embedding matrix, the social-networking system 160 may prepare an initialized term embedding matrix on one or more temporary data stores. The one or more temporary data stores may be apart from the one or more production data stores. Each column of the initialized term embedding matrix corresponds to one of the unigram or the pre-identified bi-gram appearing in the corpus of text. The social-networking system 160 may, at step 620, train term embeddings in the initialized term embedding matrix using a term embedding model. The term embedding model uses a stochastic gradient descent process with a gradient obtained via backpropagation. As an example and not by way of limitation, continuing with a prior example, the social-networking system 160 may create an initialized term embedding matrix on a temporary data store based on the identified term list. Each column of the initialized term embedding matrix corresponds to one of the unigrams or bi-grams in the identified list. The social-networking system 160 may train the term embedding matrix with an objective to maximize an average log probability

$$\frac{1}{T} {\sum }_{t = k}^{T - k} log p ( {w}_{t} \vert {w}_{t - k} , … , {w}_{t + k} )$$

w₁, w₂, w₃, . . . , w_{T} appears in the corpus of text. The social-networking system 160 may use a word2vec model for this training. After the training converges, terms with similar meaning may be mapped to a similar position in the embedding space. For example, “powerful” and “strong” may be close to each other in the embedding space, whereas “powerful” and “Paris” may be more distant. Although this disclosure describes training a term embedding matrix in a particular manner, this disclosure contemplates training a term embedding matrix in any suitable manner.

In particular embodiments, the social-networking system 160 may create, using term embeddings in the created term embedding matrix, a new entity embedding matrix, each column of which corresponds to an eligible entity in the online social network. The social-networking system 160 may generate entity embeddings for particular entities in the online social network. An eligible entity is an entity that can be represented by an entity embedding. In particular embodiments, the social-networking system 160 may determine whether an entity is an eligible entity based on the type of the entity. In order to create the new entity embedding matrix, the social-networking system 160 may identify eligible entities in the online social network from one or more verticals 164 in the online social network. As an example and not by way of limitation, the social-networking system 160 may generate entity embeddings for pages. The social-networking system 160 may search one or more verticals 164 that pages are stored on to identify each of the pages. Although this disclosure describes identifying eligible entities in a particular manner, this disclosure contemplates identifying eligible entities in any suitable manner.

In particular embodiments, the social-networking system 160 may, for each eligible entity, select text to be used for generating an entity embedding corresponding to the entity. The selected text has a determined probability of being relevant to the entity greater than a threshold probability. As an example and not by way of limitation, continuing with a prior example, the social-networking system 160 may select text from metadata, title, description, text extracted from corresponding wiki pages, and posts created by the administrator of the page within a pre-determined time range. In order to improve the quality of the selected text, the social-networking system 160 may ignore text in posts created by anonymous visitors. The social-networking system 160 may prioritize recently added text over text added long ago. As another example and not by way of limitation, the social-networking system 160 may generate entity embeddings for groups. The social-networking system 160 may select text from group posts, pinned posts, meta data, title, description, and administrator tags. Although this disclosure describes selecting text to be used for generating an entity embedding corresponding to the entity in a particular manner, this disclosure contemplates selecting text to be used for generating an entity embedding corresponding to the entity in any suitable manner.

In particular embodiments, the social-networking system 160 may determine, for each eligible entity, whether the selected text is sufficient to represent the entity. Such determination may be based on an amount of the selected text. An entity may not have enough text associated with it to generate an entity embedding that properly represents the entity. The social-networking system 160 may determine whether the selected text is sufficient to represent the entity based on the amount of text selected based on the text selection criteria. In particular embodiments, the social-networking system 160 may determine whether the selected text is sufficient to represent the entity based on any other factors. The social-networking system 160 may add each eligible entity to a training entity pool if the selected text for the eligible entity is determined to be sufficient to represent the entity. The social-networking system 160 may add each eligible entity to an inference entity pool if the selected text for the eligible entity is determined not sufficient to represent the entity. As an example and not by way of limitation, the social-networking system 160 may determine that a page for Walmart, a retailer franchise, does not have enough text to generate an entity embedding that represents the page of Walmart properly because the page for Walmart only contains a few posts comprising announcements from the company. The social-networking system 160 may add the page for Walmart to an inference entity pool. As another example and not by way of limitation, the social-networking system 160 may determine a page for Target, another retailer franchise, has enough text to generate an entity embedding that properly represents the page for Target because the page for Target contains detailed descriptions about the retailer and numerous recently created posts for promotions and sales events. The social-networking system 160 may add the page for Target to a training entity pool. Although this disclosure describes classifying eligible entities in a particular manner, this disclosure contemplates classifying eligible entities in any suitable manner.

In particular embodiments, the social-networking system 160 may prepare an initialized entity embedding matrix, on one or more temporary data stores. Each column of the initialized entity embedding matrix corresponds to one of the entities in the training entity pool. The social-networking system 160 may train an entity embedding matrix for entities in the training entity pool because the entities in the training entity pool have enough text to generate the corresponding entity embeddings. As a first step to train the entity embeddings, the social-networking system 160 may prepare an initialized entity embedding matrix, each column of which is an initialized entity embedding corresponding to an entity in the training entity pool. In particular embodiments, each element of an initialized entity embedding may be set to zero. In particular embodiments, each element of an initialized entity embedding may be set to a particular initial value. The social-networking system 160 may train entity embeddings in the initialized entity embedding matrix using an entity embedding model that uses a stochastic gradient descent process with a gradient obtained via backpropagation. As an example and not by way of limitation, the social-networking system 160 may prepare an empty entity embedding matrix on one or more temporary data stores at the beginning. For each entity in the training entity pool, the social-networking system 160 may add an initialized entity embedding corresponding to the entity to the entity embedding matrix as a column. Each column of an initialized entity embedding is set to zero. Since the page for Target was added to the training entity pool in the previous example, the social-networking system 160 may generate an initialized entity embedding for the page of Target and add the initialized entity embedding to the entity embedding matrix. Once the social-networking system 160 completes generating the initialized entity embedding matrix, the social-networking system 160 may train the entity embeddings in the entity embedding matrix using an extension of paragraph2vector model. Although this disclosure describes preparing an initialized entity embedding matrix in a particular manner, this disclosure contemplates preparing an initialized entity embedding matrix in any suitable manner.

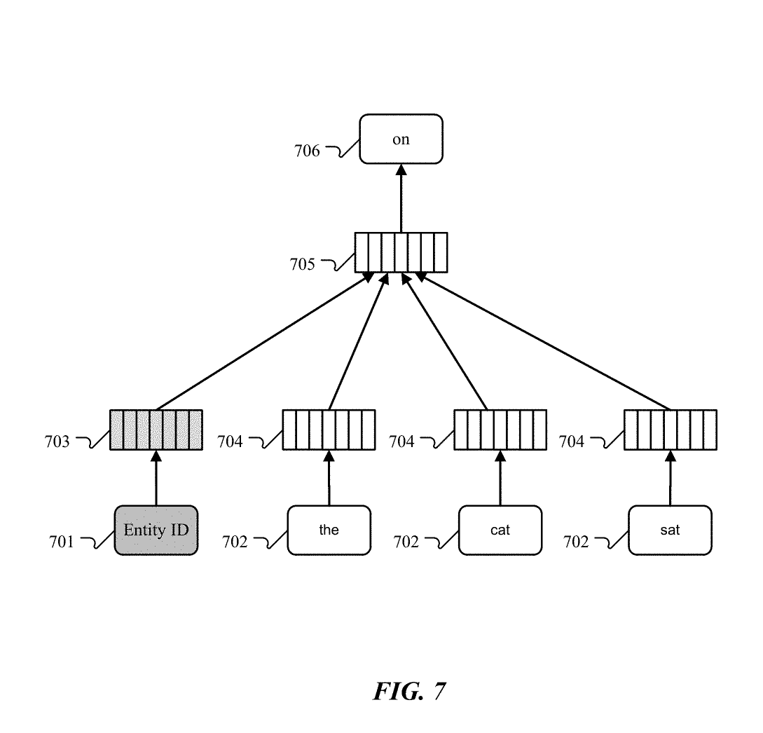

In particular embodiments, the entity embedding model may be a distributed memory model. FIG. 7 illustrates an example training process of the distributed memory model. With the distributed memory model, the social-networking system 160 may associate, for each entity in the training entity pool, an entity identifier 701 for the entity and the corresponding initialized entity embedding 703 in the initialized entity embedding matrix. The social-networking system 160 may retrieve, for each entity in the training entity pool, term embeddings 704 corresponding to terms 702 in the selected text from the term embedding matrix. The social-networking system 160 may iteratively train the initialized entity embedding matrix using the stochastic gradient descent process. In an iteration of the stochastic gradient descent process, the social-networking system 160 may sample, for each entity in the training entity pool, a term sequence of k terms from a sliding window over the selected text, where k is a fixed-length of the term sequence. The social-networking system 160 may perform a backpropagation process on a current iteration of the initialized entity embedding matrix in order to maximize, for each entity embedding in the entity embedding matrix, a probability that an embedding vector 705 that is a combination of the entity embedding 703 and term embeddings 704 corresponding to the first k-1 terms 702 of the sampled term sequence correctly predicts a k-th term 706 in the term sequence. In particular embodiments, the combination of the entity embedding 703 and term embeddings 704 may comprise taking an average of the entity embedding 703 and the term embeddings 704. In particular embodiments, the combination of the entity embedding 703 and term embeddings 704 may comprise concatenating the entity embedding 703 with the term embeddings 704. As an example and not by way of limitation, illustrated in FIG. 7, the social-networking system 160 may associated an entity identifier 701, for each entity in the training entity pool, with the corresponding entity embedding 703 in the entity embedding matrix. In an iteration illustrated in FIG. 7, the social-networking system 160 may sample “the cat sat on” from the selected text for the particular entity illustrated in FIG. 7 because k is four in this example. The social-networking system 160 may retrieve term embeddings 704 corresponding to the first 3 terms 702 of the sampled term sequence from the term embedding matrix. The social-networking system 160 may calculate an embedding vector 705 by taking average of the entity embedding 703 and the term embeddings 704. In particular embodiments, the social-networking system 160 may calculate the embedding vector 705 by concatenating the entity embedding 703 with the term embeddings 704. The social-networking system 160 may perform a backpropagation process on a current iteration of the initialized entity embedding matrix in order to maximize a probability, for each entity embedding in the entity embedding matrix, that the calculated embedding vector 705 correctly predicts “on” 706. Although this disclosure describes training entity embeddings with the distributed memory model in a particular manner, this disclosure contemplates training entity embeddings with the distributed memory model in any suitable manner.

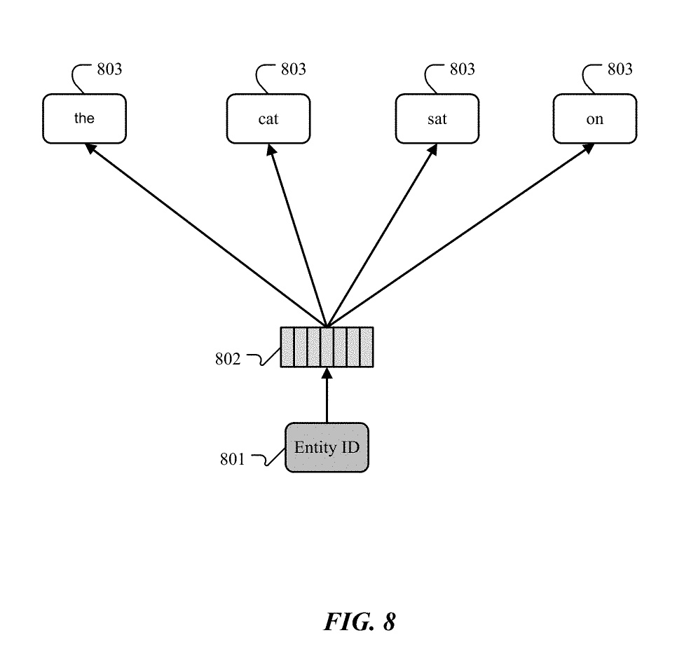

In particular embodiments, the entity embedding model may be a distributed bag-of-words model. FIG. 8 illustrates an example training process of the distributed bag of words model. In the distributed memory model, an embedding vector 705, the combination of the entity embedding 703 with the term embeddings 704, may be supposed to predict the next term 705 correctly. In the distributed bag-of-words model, the entity embedding may be supposed to predict terms randomly sampled from the selected text. With the distributed bag-of-words model, the social-networking system 160 may associate, for each entity in the training entity pool, an entity identifier 801 for the entity and the corresponding initialized entity embedding 802 in the initialized entity embedding matrix. The social-networking system 160 may iteratively train the initialized entity embedding matrix using the stochastic gradient descent process. In each iteration of the stochastic gradient descent process, the social-networking system 160 may sample, for each entity in the training entity pool, a term sequence of k-terms from a sliding window over the selected text, where k is a fixed-length of the term sequence and the social-networking system 160 may perform a backpropagation process on a current iteration of the initialized entity embedding matrix in order to maximize, for each entity embedding in the entity embedding matrix, a probability that the entity embedding 802 correctly predicts each term 803 in the sampled term sequence. As an example and not by way of limitation, illustrated in FIG. 8, the social-networking system 160 may associate an entity identifier 801, for each entity in the training entity pool, with the corresponding entity embedding 802 in the entity embedding matrix. In an iteration illustrated in FIG. 8, the social-networking system 160 may sample “the cat sat on” from the selected text for the particular entity illustrated in FIG. 8 because k is four in this example. The social-networking system 160 may perform a backpropagation process on a current iteration of the initialized entity embedding matrix in order to maximize a probability, for each entity embedding in the entity embedding matrix, that the entity embedding 802 correctly predicts each term 803 in the sampled term sequence. Although this disclosure describes training entity embeddings with the distributed bag-of-words model in a particular manner, this disclosure contemplates training entity embeddings with the distributed bag-of-words model in any suitable manner.

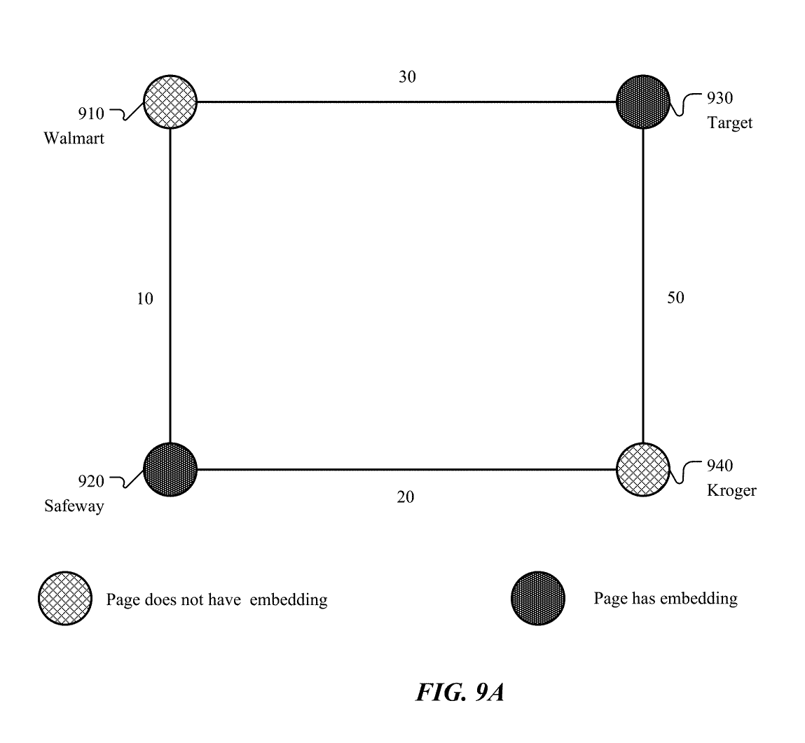

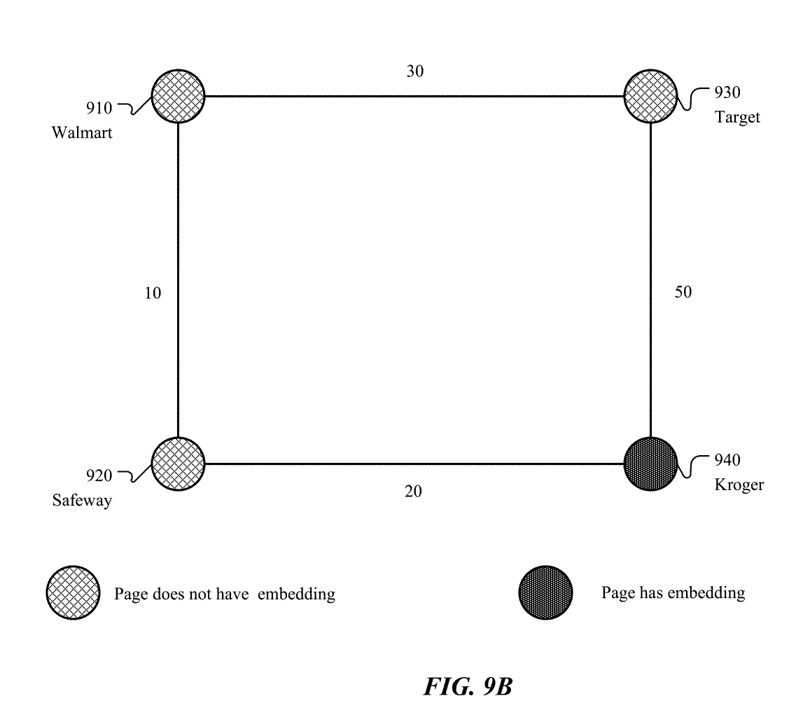

In particular embodiments, after training entity embeddings for the eligible entities in the training entity pool, the social-networking system 160 may generate an entity embedding for each entity in the inference entity pool by performing an embedding interpolation. An entity in the online social network may be represented by a node in a social graph 200. The entity may be connected to neighboring entities through edges. Though an entity may not have enough text for generating a corresponding entity embedding, the entity may have neighboring entities that have corresponding entity embeddings available because the neighboring entities have enough text for generating entity embeddings. The social-networking system 160 may use entity embeddings corresponding to those neighboring entities to generate an entity embedding corresponding to the entity in the inference entity pool. For the embedding interpolation for each entity in the inference entity pool, the social-networking system 160 may identify one or more neighboring entities of the entity that have entity embeddings stored in the one or more temporary data stores from the social graph 200. The social-networking system 160 may determine a weight for each edge connecting the entity and each of the identified one or more neighboring entity. The weight for each edge may be proportional to the number of co-visits by users of the online social network to the entity and the identified neighboring entity. The weights may be normalized so that a sum of the weights is 1. The social-networking system 160 may generate an entity embedding corresponding to the entity by taking a weighted average of entity embeddings corresponding to the identified neighboring entities. FIG. 9A illustrates an example where an entity has neighboring entities that have associated entity embeddings. As an example and not by way of limitation, as illustrated in FIG. 9A, the page of Walmart is currently in the inference entity pool. The social-networking system 160 may identify neighboring entities of a page for Walmart 910: a page for Safeway 920, another retailer franchise, and a page for Target. The social-networking system 160 may determine weight on an edge by counting number of co-visits by users to the entities represented by nodes connected by the edge. In the example illustrated in FIG. 9A, pages of Walmart and Safeway were co-visited by 10 million users over the last 20 days while pages of Walmart and Target were co-visited by 30 million users over the same timeframe. The social-networking system 160 may compute an entity embedding by taking a weighted average of entity embedding corresponding to Safeway page and entity embedding corresponding to Target page. The weights on the edges may be normalized so that the sum of the weights is one: the weight for Safeway page embedding becomes 0.25 while the weight for Target page becomes 0.75. Although this disclosure describes embedding interpolation by taking a weighted average of embeddings corresponding neighboring entities in a particular manner, this disclosure contemplates embedding interpolation by taking a weighted average of embeddings corresponding neighboring entities in any suitable manner.

In particular embodiments, the social-networking system 160 may perform repeated random walk with restart (RWR) in order to determine degrees of relevance between a first entity and a plurality of second entities that have corresponding entity embeddings if the first entity in the inference entity pool has no neighboring entities with an entity embedding stored in the one or more temporary data stores in the social graph 200 of the online social network. A first entity in the inference entity pool may not have any neighboring entity in the social graph 200 that has corresponding entity embedding stored in the one or more temporary data stores. The social-networking system 160 may need to compute an entity embedding for the first entity by taking a weighted average of entity embeddings corresponding to second entities that are not direct neighbors of the first entity. Because the second entities are not direct neighbors of the first entity in the social graph 200, weights assigned on the edges may not be used while the social-networking system 160 takes the weighted average. Instead, the social-networking system 160 may estimate degrees of relevance between the first entity and a plurality of second entities and apply a weight proportional to the estimated degree of relevance between the first entity and a particular second entity when the social-networking system 160 computes the entity embedding for the first entity by taking the weighted average of entity embeddings corresponding to the second entities. The social-networking system 160 may perform repeated RWR in order to determine the degrees of relevance between the first entity and a plurality of second entities. Before performing repeated RWR, the social-networking system 160 may determine a weight for each edge connecting two entities. The weight for each edge may be proportional to the number of co-visits by users of the online social network to two entities that are connected by the edge. The social-networking system 160 may determine weights of edges within the threshold degree of separation of the first entity in the social graph 200 in order to save computing resources. The social-networking system 160 may calculate a number of recorded visits per entity using a repeated random walk with restart on the social graph 200 for a pre-determined number of random walks. For a random walk with restart procedure, the social-networking system 160 may set a node representing the first entity to a source node. The social-networking system 160 may perform a walk from the source node to a neighboring destination node in the social graph 200 of the online social network. Walking to the destination node makes the destination node a source node for a next walk. When more than one neighboring nodes are available from the source node, the neighboring destination node is randomly chosen based on the determined weights on the edges between the source node and the neighboring nodes. The social-networking system 160 may repeat the walks for a randomly chosen number of times and record, at the end of the walks for the randomly chosen number of times, a second entity represented by the destination node if the second entity has a corresponding entity embedding. The following pseudo code shows how RWR works:

| | |
|---|---|
| 1. | Start procedure |
| 2. | RWR (first_node) |
| 3. | For i = 1 to N //N is a pre-determined number of trials |
| 4. | src_node = first node |
| 5. | While ( continue(rand) ) //randomly stop walks |
| 6. | dest_node = random_neighbor(rand, src_node) // |

Randomly select one of the neighbor nodes from the source node,
selection is proportional to edge weights

| | |
|---|---|
| 7. | src_node = dest_node |
| 8. | End While |
| 9. | If (dest_node.embedding <> NULL) // dest_node has an |

embedding

| | |
|---|---|
| 10. | record_visit( dest_node) // record a vist to the |

dest_node

| | |
|---|---|
| 11. | End If |
| 12. | End For |
| 13. | End procedure |

After performing random walk with restart procedures for a pre-determined number of times, the social-networking system 160 may calculate, for each of the recorded second entities, a degree of relevance of the first entity to the second entity based on a number of recorded visits to the second entity out of a total number of recorded visits. The social-networking system 160 may generate an entity embedding for the first entity by taking a weighted average of entity embeddings corresponding to the recorded second entities, where the applied weights in the weighted average are proportional to the calculated degrees of relevance, and the applied weights are normalized so that a sum of the weights is 1. FIG. 9B illustrates an example where an entity does not have neighboring entities that have corresponding entity embeddings. As an example and not by way of limitation, illustrated in FIG. 9B, a page for Walmart 910 has two neighbors in the social graph 200, a page for Safeway 920 and a page for Target 930. Neither Safeway page 920 nor Target page 930 have corresponding entity embedding. In such situations, the social-networking system 160 may perform RWR in order to determine degrees of relevance of the page of Walmart 910 to a plurality of entities with corresponding entity embeddings (e.g., a page of Kroger 940, another retailer franchise). In particular embodiments, the social-networking system 160 may consider entities within a threshold degree of separation from the page of Walmart for the sake of computation. After determining the degrees of relevance from the page of Walmart to the plurality of entities using RWR, the social-networking system 160 may compute an entity embedding for the page of Walmart by taking a weighted average of entity embeddings corresponding to the plurality of entities. Applied weight on each entity embedding for the weighted average is proportional to the degree of relevance of the Walmart page to the particular entity. Although this disclosure describes embedding interpolation when an entity does not have any neighboring entity with corresponding entity embedding in a particular manner, this disclosure contemplates embedding interpolation when an entity does not have any neighboring entity with corresponding entity embedding in any suitable manner.

In particular embodiments, once the social-networking system 160 generates an entity embedding for an entity in the inference entity pool, the social-networking system 160 may add the generated entity embedding into the entity embedding matrix. As an example and not by way of limitation, illustrated in FIG. 9A, the social-networking system 160 may compute an entity embedding for Walmart page 901 by taking weighted average of entity embedding for Safeway page 920 and entity embedding for Target page 930. The social-networking system 160 may add the computed entity embedding into the entity embedding matrix on the one or more temporary data stores. As another example and not by way of limitation, illustrated in FIG. 9B, the social-networking system 160 may determine degrees of relevance between Walmart page 901 and a plurality of entities in the social graph 200 that have corresponding entity embeddings by performing RWR. The social-networking system 160 may compute an entity embedding for Walmart page 901 by taking a weighted average of entity embeddings for the plurality of entities. The social-networking system 160 may add the computed entity embedding for Walmart page 901 into the entity embedding matrix on the one or more temporary data stores. Although this disclosure describes adding an entity embedding generated by an entity interpolation into the entity embedding matrix in a particular manner, this disclosure contemplates adding an entity embedding generated by an entity interpolation into the entity embedding matrix in any suitable manner.

In particular embodiments, the social-networking system 160 may, once creating the new term embedding matrix and the new entity embedding matrix has completed, replace an existing term embedding matrix with the new term embedding matrix and an existing entity embedding matrix with the new entity embedding matrix on the one or more production data stores. Generating new term embedding matrix and entity embedding matrix may take long time. In order to maintain consistent versioning for downstream access, the social-networking system 160 may deploy new version term embedding matrix and entity embedding matrix after generating new version matrices on one or more temporary data stores. Because entity embeddings may be used by a plurality of applications, the social-networking system 160 may deploy the new version term embedding matrix and entity embedding matrix onto multiple production data stores in various format. As an example and not by way of limitation, as illustrated in FIG. 6, the social-networking system 160 may deploy new version of term and entity embedding matrices 601 at step 630. The term and entity embedding matrices have been generated on one or more temporary data stores. The social-networking system 160 may deploy multiple copies of new version term embedding matrix and entity embedding matrix in various format onto a plurality of production data stores 164 because services utilizing the term and entity embeddings may utilize the embeddings in different formats. In the example illustrated in FIG. 6, the social-networking system 160 deploys term and entity embedding matrices for offline analysis 602, term and entity embedding matrices in compressed format for backend applications 603, and term and entity embedding matrices for online services 604. The term and entity embedding matrices for offline analysis 602 and the term and entity embedding matrices in compressed format for backend applications 603 may be used together when the social-networking system 160 performs offline analysis at step 640. When the social-networking system 160 generates and evaluates a query embedding at step 650, the social-networking system 160 may use the term and entity embedding matrices in compressed format for backend applications 603 and the term and entity embedding matrices for online services 604 together. Also, when the social-networking system 160 performs candidate ranking and indexing for a search query at step 660, the social-networking system 160 may use the term and entity embedding matrices in compressed format for backend applications 603 and the term and entity embedding matrices for online services 604 together. Although this disclosure describes deploying term and entity embedding matrices in a particular manner, this disclosure contemplates deploying term and entity embedding matrices in any suitable manner.

In particular embodiments, the social-networking system 160 may receive a search query for entities in an online social network from a client system 130 associated with a user of the online social network, where entities comprise one or more of pages, groups, or users. The search query may comprise one or more n-grams. The user may search for entities in the online social network by providing a short phrase describing the entities, generally referred to as a “search query,” to the social-networking system 160. The client system 130 may access the social-networking system 160 using a web browser 132, or a native application associated with the social-networking system 160 (e.g., a mobile social-networking application, a messaging application, another suitable application, or any combination thereof), either directly, via a network 110, or via a third-party system 170. When the user enters the search query in the query field and clicks a “search” button, hits enter, or takes another action that has an equivalent effect, the client system 130 may send the search query to the social-networking system 160 using, for example, an HTTP request. As an example and not by way of limitation, the social-networking system 160 may receive a search query “Manchester united players” from a client system 130 when a user associated with the client system 130 types the string “Manchester united players” in the query field and clicks a “search” button from his web browser 132. Although this disclosure describes receiving a search query for entities in a particular manner, this disclosure contemplates receiving a search query for entities in any suitable manner.

In particular embodiments, the social-networking system 160 may generate a query embedding corresponding to the search query using an entity embedding model. In order to generate the query embedding, the social-networking system 160 may parse the search query to identify one or more unique entities associated with the online social network referenced in the search query and generate one or more term embeddings representing the one or more n-grams of the search query, respectively, using a term embedding model. The query embedding represents the search query as a point in a d-dimensional embedding space. Each term embedding for an n-gram referencing one of the unique entities is a term embedding for the respective unique entity. The social-networking system 160 may generate, using the entity embedding model, a query embedding using the generated one or more term embeddings corresponding to one or more n-grams of the search query. The parameters on the entity embedding model are set based on a training procedure to generate the entity embedding matrix on the one or more production data stores 164. The social-networking system 160 may apply the parameters set based on the training when the social-networking system 160 generates the term embedding. As an example and not by way of limitation, continuing with a prior example, the social-networking system 160 may identify “Manchester United” as an English Premier League football team (which may correspond to a particular node in the social graph 200) by parsing the search query. The social-networking system 160 may prepare term embeddings for the given search query “Manchester United players” where the term embedding for “Manchester United” is an embedding for the football team and the term embedding for “players” is a term embedding in the term embedding matrix in the one or more production data stores 164. The social-networking system 160 may generate a query embedding based on the prepared term embeddings using the entity embedding model. The social-networking system 160 may apply the parameters that have been set during the training procedure for the entity embedding matrix in the one or more production data stores 164 when the social-networking system 160 generates the query embedding. Although this disclosure describes generating a query embedding in a particular manner, this disclosure contemplates generating a query embedding in any suitable manner.

In particular embodiments, the social-networking system 160 may retrieve a plurality of entity embeddings corresponding to a plurality of entities, respectively, from one or more production data stores 164. Each entity embedding represents the corresponding entity as a point in the d-dimensional embedding space. In particular embodiments, the social-networking system 160 may apply one or more filters while retrieving the plurality of entity embeddings. For example, the social-networking system 160 may retrieve one or more entities in the online social networking matching the one or more n-grams of the search query. As an example and not by way of limitation, the social-networking system 160 may retrieve entity embeddings from the one or more production data stores 164. In particular embodiments, the social-networking system 160 may retrieve entity embeddings within a threshold distance from the query embedding in the embedding space. Although this disclosure describes retrieving entity embeddings in a particular manner, this disclosure contemplates retrieving entity embeddings in any suitable manner.

In particular embodiments, the social-networking system 160 may calculate a similarity metric between the query embedding and the entity embedding for each of the retrieved entity embeddings. The similarity metric measures a degree of similarity of the query embedding to the entity embedding. The similarity metric may be a cosign similarity. In particular embodiments, the social-networking system 160 may rank the entities based on their respective calculated similarity metrics. As an example and not by way of limitation, the social-networking system 160 may calculate a cosign similarity, for each of the retrieved entity embeddings, between the query embedding and the entity embedding. The social-networking system 160 may rank the retrieved entities based on their respective cosign similarity to the query embedding. Continuing with a prior example, pages for current Manchester United players (e.g., Paul Pogba and Zlatan Ibrahimovic) as well as pages for former Manchester United players (e.g., Ryan Giggs and Patrice Evra) may rank high as candidates for the search query “Manchester United players.” Although this disclosure describes ranking candidates for a search query in a particular manner, this disclosure contemplates ranking candidates for a search query in any suitable manner.

In particular embodiments, the social-networking system 160 may send instructions for presenting a search-results interface to the client system 130 in response to the search query. The client system 130 may generate a search-results interface and may present the interface to the querying user as a response to the query request. The search-results interface may comprise one or more search results corresponding to one or more of the entities, respectively, where the one or more search results may be presented in ranked order based on the rankings of their corresponding entities. As an example and not by way of limitation, the social-networking system 160 may send an HTTP response with instructions for generating a search-results interface to a client system 130. On receiving the HTTP response from the social-networking system 160, the client system 130 may present a search-results page on the web browser. The interface may comprise references to a number of the high-rank entities. The user may be able to navigate towards the lower ranking entities. Although this disclosure describes providing search results in a particular manner, this disclosure contemplates providing search results in any suitable manner.

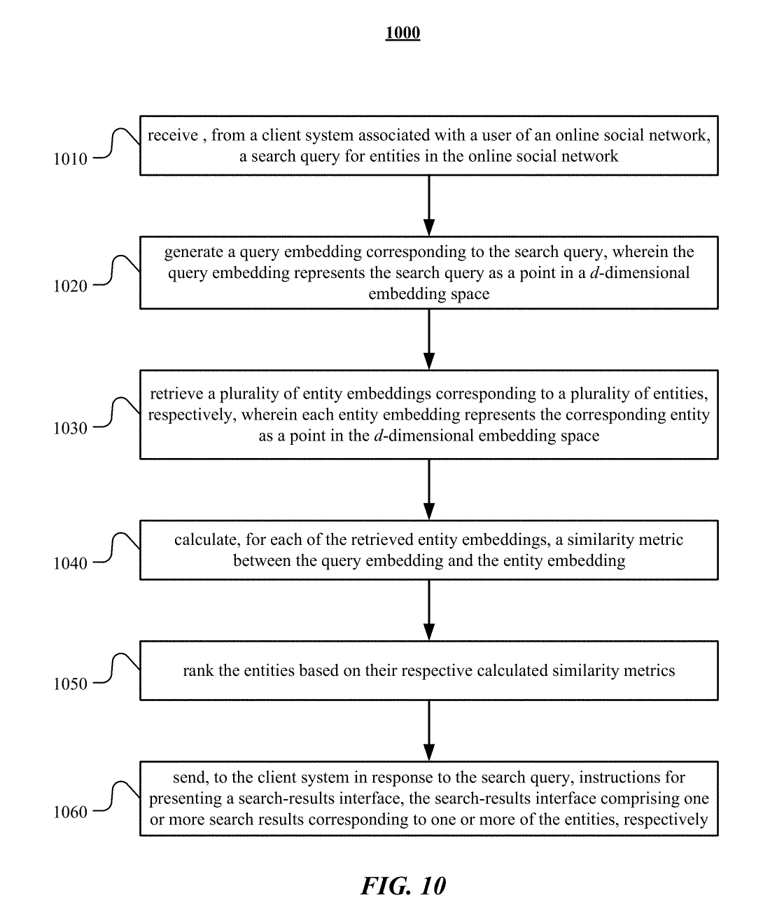

FIG. 10 illustrates an example method for processing a query for entities in the online social network with pre-calculated entity embeddings. The method may begin at step 1010, where the social-networking system 160 may receive, from a client system associated with a user of an online social network, a search query for entities in the online social network, the search query comprising one or more n-grams. At step 1020, the social-networking system 160 may generate, using an entity embedding model, a query embedding corresponding to the search query, wherein the query embedding represents the search query as a point in a d-dimensional embedding space. At step 1030, the social-networking system 160 may retrieve, from one or more production data stores, a plurality of entity embeddings corresponding to a plurality of entities, respectively, wherein each entity embedding represents the corresponding entity as a point in the d-dimensional embedding space, and wherein the entity embeddings in the production data stores are generated using the entity embedding model. At step 1040, the social-networking system 160 may calculate, for each of the retrieved entity embeddings, a similarity metric between the query embedding and the entity embedding, wherein the similarity metric measures a degree of similarity of the query embedding to the entity embedding. At step 1050, the social-networking system 160 may rank the entities based on their respective calculated similarity metrics. At step 1060, the social-networking system 160 may send, to the client system in response to the search query, instructions for presenting a search-results interface, the search-results interface comprising one or more search results corresponding to one or more of the entities, respectively, the one or more search results being presented in ranked order based on the rankings of their corresponding entities. Particular embodiments may repeat one or more steps of the method of FIG. 10, where appropriate. Although this disclosure describes and illustrates particular steps of the method of FIG. 10 as occurring in a particular order, this disclosure contemplates any suitable steps of the method of FIG. 10 occurring in any suitable order. Moreover, although this disclosure describes and illustrates an example method for processing a query for entities in the online social network with pre-calculated entity embeddings including the particular steps of the method of FIG. 10, this disclosure contemplates any suitable method for processing a query for entities in the online social network with pre-calculated entity embeddings including any suitable steps, which may include all, some, or none of the steps of the method of FIG. 10, where appropriate. Furthermore, although this disclosure describes and illustrates particular components, devices, or systems carrying out particular steps of the method of FIG. 10, this disclosure contemplates any suitable combination of any suitable components, devices, or systems carrying out any suitable steps of the method of FIG. 10.

### Performance Analysis

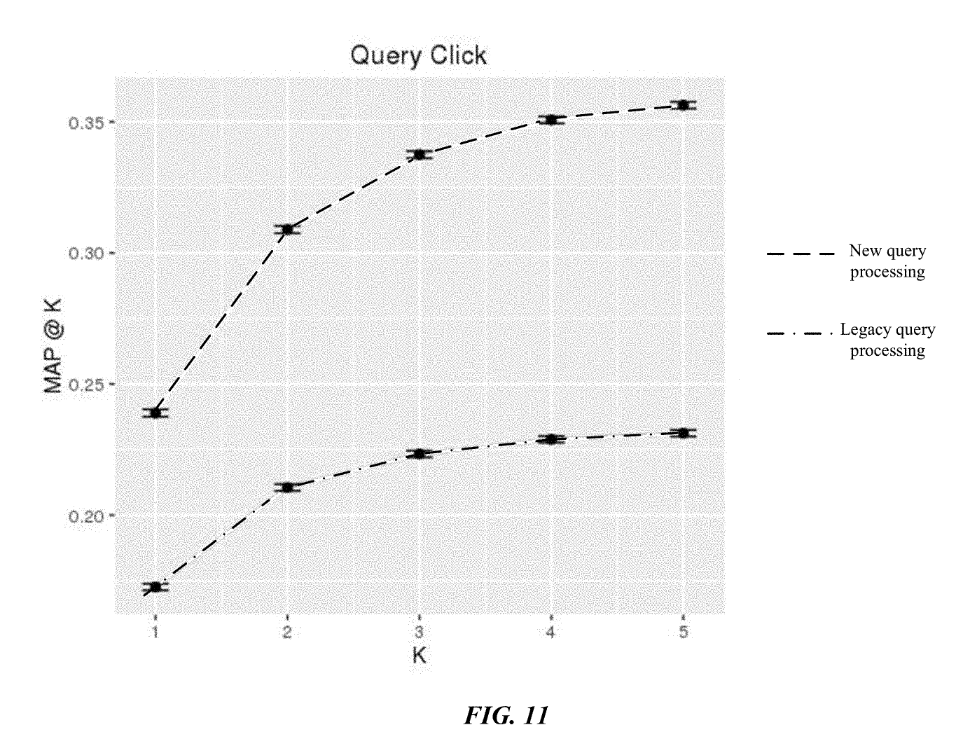

Query Clicks—The Mean Average Precision for top-k (MAP@K) candidates across all queries in a sample 24 hour period was computed for a performance analysis purpose. All the entities that had an impression were considered as candidates. Precision for each query was computed using the ranked order of the candidate list. The ranking for the evaluation was obtained using the cosine similarity between query embedding and entity embedding. If all clicked entities appear in the top of the list across all queries, then MAP is 1.0. FIG. 11 illustrates a performance comparison for query clicks. The analysis shows that search processing based on new entity embeddings out-performs the previous production solution (±38.5% MAP).

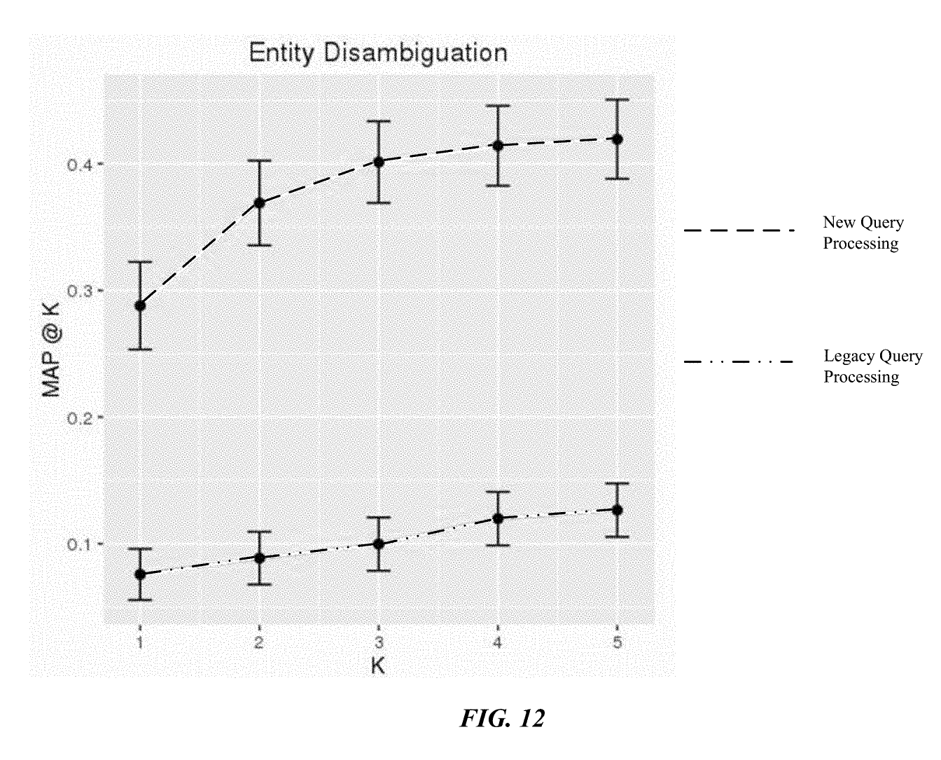

Entity Disambiguation—A plurality of queries that comprise an entity name and few additional words for context were tested. The entity names for the plurality of queries are sourced from Wikipedia mentions table. For example, when a query “Max Payne movie review” is received, the candidates can be “Max Payne Game”, “Max Payne (character)”, and “Max Payne (film).” The best candidate the entity embeddings based search processing module produces is “Max Payne (film),” which is the correct answer (i.e. MAP is 1.0). FIG. 12 illustrates a performance comparison for entity disambiguation. The entity embeddings based search processing is able to disambiguate candidates for entity matching and shows 3 times MAP increase compare to the previous version.

### Systems and Methods

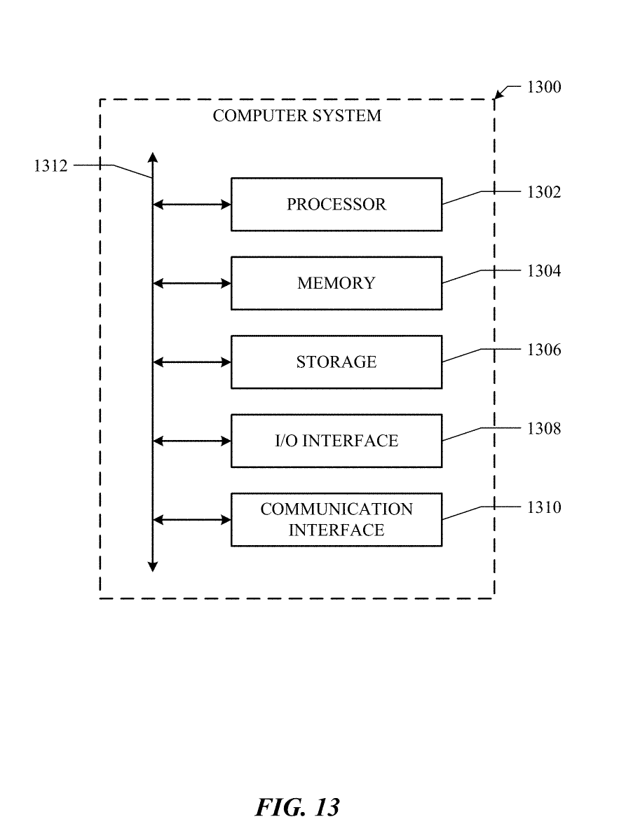

FIG. 13 illustrates an example computer system 1300. In particular embodiments, one or more computer systems 1300 perform one or more steps of one or more methods described or illustrated herein. In particular embodiments, one or more computer systems 1300 provide functionality described or illustrated herein. In particular embodiments, software running on one or more computer systems 1300 performs one or more steps of one or more methods described or illustrated herein or provides functionality described or illustrated herein. Particular embodiments include one or more portions of one or more computer systems 1300. Herein, reference to a computer system may encompass a computing device, and vice versa, where appropriate. Moreover, reference to a computer system may encompass one or more computer systems, where appropriate.

This disclosure contemplates any suitable number of computer systems 1300. This disclosure contemplates computer system 1300 taking any suitable physical form. As example and not by way of limitation, computer system 1300 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 1300 may include one or more computer systems 1300; be unitary or distributed; span multiple locations; span multiple machines; span multiple data centers; or reside in a cloud, which may include one or more cloud components in one or more networks. Where appropriate, one or more computer systems 1300 may perform without substantial spatial or temporal limitation one or more steps of one or more methods described or illustrated herein. As an example and not by way of limitation, one or more computer systems 1300 may perform in real time or in batch mode one or more steps of one or more methods described or illustrated herein. One or more computer systems 1300 may perform at different times or at different locations one or more steps of one or more methods described or illustrated herein, where appropriate.

In particular embodiments, computer system 1300 includes a processor 1302, memory 1304, storage 1306, an input/output (I/O) interface 1308, a communication interface 1310, and a bus 1312. Although this disclosure describes and illustrates a particular computer system having a particular number of particular components in a particular arrangement, this disclosure contemplates any suitable computer system having any suitable number of any suitable components in any suitable arrangement.

In particular embodiments, processor 1302 includes hardware for executing instructions, such as those making up a computer program. As an example and not by way of limitation, to execute instructions, processor 1302 may retrieve (or fetch) the instructions from an internal register, an internal cache, memory 1304, or storage 1306; decode and execute them; and then write one or more results to an internal register, an internal cache, memory 1304, or storage 1306. In particular embodiments, processor 1302 may include one or more internal caches for data, instructions, or addresses. This disclosure contemplates processor 1302 including any suitable number of any suitable internal caches, where appropriate. As an example and not by way of limitation, processor 1302 may include one or more instruction caches, one or more data caches, and one or more translation lookaside buffers (TLBs). Instructions in the instruction caches may be copies of instructions in memory 1304 or storage 1306, and the instruction caches may speed up retrieval of those instructions by processor 1302. Data in the data caches may be copies of data in memory 1304 or storage 1306 for instructions executing at processor 1302 to operate on; the results of previous instructions executed at processor 1302 for access by subsequent instructions executing at processor 1302 or for writing to memory 1304 or storage 1306; or other suitable data. The data caches may speed up read or write operations by processor 1302. The TLBs may speed up virtual-address translation for processor 1302. In particular embodiments, processor 1302 may include one or more internal registers for data, instructions, or addresses. This disclosure contemplates processor 1302 including any suitable number of any suitable internal registers, where appropriate. Where appropriate, processor 1302 may include one or more arithmetic logic units (ALUs); be a multi-core processor; or include one or more processors 1302. Although this disclosure describes and illustrates a particular processor, this disclosure contemplates any suitable processor.

In particular embodiments, memory 1304 includes main memory for storing instructions for processor 1302 to execute or data for processor 1302 to operate on. As an example and not by way of limitation, computer system 1300 may load instructions from storage 1306 or another source (such as, for example, another computer system 1300) to memory 1304. Processor 1302 may then load the instructions from memory 1304 to an internal register or internal cache. To execute the instructions, processor 1302 may retrieve the instructions from the internal register or internal cache and decode them. During or after execution of the instructions, processor 1302 may write one or more results (which may be intermediate or final results) to the internal register or internal cache. Processor 1302 may then write one or more of those results to memory 1304. In particular embodiments, processor 1302 executes only instructions in one or more internal registers or internal caches or in memory 1304 (as opposed to storage 1306 or elsewhere) and operates only on data in one or more internal registers or internal caches or in memory 1304 (as opposed to storage 1306 or elsewhere). One or more memory buses (which may each include an address bus and a data bus) may couple processor 1302 to memory 1304. Bus 1312 may include one or more memory buses, as described below. In particular embodiments, one or more memory management units (MMUs) reside between processor 1302 and memory 1304 and facilitate accesses to memory 1304 requested by processor 1302. In particular embodiments, memory 1304 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1304 may include one or more memories 1304, where appropriate. Although this disclosure describes and illustrates particular memory, this disclosure contemplates any suitable memory.

In particular embodiments, storage 1306 includes mass storage for data or instructions. As an example and not by way of limitation, storage 1306 may include a hard disk drive (HDD), a floppy disk drive, flash memory, an optical disc, a magneto-optical disc, magnetic tape, or a Universal Serial Bus (USB) drive or a combination of two or more of these. Storage 1306 may include removable or non-removable (or fixed) media, where appropriate. Storage 1306 may be internal or external to computer system 1300, where appropriate. In particular embodiments, storage 1306 is non-volatile, solid-state memory. In particular embodiments, storage 1306 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1306 taking any suitable physical form. Storage 1306 may include one or more storage control units facilitating communication between processor 1302 and storage 1306, where appropriate. Where appropriate, storage 1306 may include one or more storages 1306. Although this disclosure describes and illustrates particular storage, this disclosure contemplates any suitable storage.

In particular embodiments, I/O interface 1308 includes hardware, software, or both, providing one or more interfaces for communication between computer system 1300 and one or more I/O devices. Computer system 1300 may include one or more of these I/O devices, where appropriate. One or more of these I/O devices may enable communication between a person and computer system 1300. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 1308 for them. Where appropriate, I/O interface 1308 may include one or more device or software drivers enabling processor 1302 to drive one or more of these I/O devices. I/O interface 1308 may include one or more I/O interfaces 1308, where appropriate. Although this disclosure describes and illustrates a particular I/O interface, this disclosure contemplates any suitable I/O interface.

In particular embodiments, communication interface 1310 includes hardware, software, or both providing one or more interfaces for communication (such as, for example, packet-based communication) between computer system 1300 and one or more other computer systems 1300 or one or more networks. As an example and not by way of limitation, communication interface 1310 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1310 for it. As an example and not by way of limitation, computer system 1300 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1300 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 1300 may include any suitable communication interface 1310 for any of these networks, where appropriate. Communication interface 1310 may include one or more communication interfaces 1310, where appropriate. Although this disclosure describes and illustrates a particular communication interface, this disclosure contemplates any suitable communication interface.

In particular embodiments, bus 1312 includes hardware, software, or both coupling components of computer system 1300 to each other. As an example and not by way of limitation, bus 1312 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1312 may include one or more buses 1312, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

### Miscellaneous

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

### REFERENCES

1. Q. Le and T. Mikolov, “Distributed Representation of Sentences and Documents,” In Proceedings of ICML 2014.

What is claimed is:

1. A method comprising, by a computing device:
receiving, from a client system associated with a user of an online social network, a search query for entities in the online social network, the search query comprising one or more n-grams;
generating, using an entity embedding model, a query embedding corresponding to the search query, wherein the query embedding represents the search query as a point in a d-dimensional embedding space;
retrieving, from one or more production data stores, a plurality of entity embeddings corresponding to a plurality of entities, respectively, wherein each entity embedding represents the corresponding entity as a point in the d-dimensional embedding space, and wherein the entity embeddings in the production data stores are generated using the entity embedding model;
calculating, for each of the retrieved entity embeddings, a similarity metric between the query embedding and the entity embedding, wherein the similarity metric measures a degree of similarity of the query embedding to the entity embedding;
ranking the entities based on their respective calculated similarity metrics; and
sending, to the client system in response to the search query, instructions for presenting a search-results interface, the search-results interface comprising one or more search results corresponding to one or more of the entities, respectively, the one or more search results being presented in ranked order based on the rankings of their corresponding entities.

2. The method of claim 1, further comprising identifying one or more entities in the online social networking matching the one or more n-grams of the search query.

3. The method of claim 1, further comprising:
receiving a trigger to deploy a new version of the entity embeddings stored in the one or more production data stores;
creating a new term embedding matrix, wherein each column of the term embedding matrix corresponds to a unigram or a pre-identified bi-gram appearing in a corpus of text extracted from objects in the online social network;
creating, using term embeddings in the term embedding matrix, a new entity embedding matrix, wherein each column of the entity embedding matrix corresponds to an eligible entity in the online social network, wherein an eligible entity is an entity that can be represented by an entity embedding; and
replacing, on the one or more production data stores, an existing term embedding matrix with the new term embedding matrix and an existing entity embedding matrix with the new entity embedding matrix.

4. The method of claim 3, wherein the trigger is an expiration of a version update timer associated with the entity embeddings stored in the one or more production data stores.

5. The method of claim 3, wherein creating the new term embedding matrix comprises:
preparing, on one or more temporary data stores, an initialized term embedding matrix, wherein each column of the term embedding matrix corresponds to one of the unigram or the pre-identified bi-gram appearing in the corpus of text; and
training, using a term embedding model, term embeddings in the initialized term embedding matrix, wherein the term embedding model uses a stochastic gradient descent process with a gradient obtained via backpropagation.

6. The method of claim 3, wherein creating the new entity embedding matrix comprises:
identifying, from one or more verticals in the online social network, eligible entities in the online social network;
selecting, for each eligible entity, text to be used for generating an entity embedding corresponding to the entity, wherein the selected text has a determined probability of being relevant to the entity greater than a threshold probability;
determining, for each eligible entity, whether the selected text is sufficient to represent the entity, wherein the determination is based on an amount of the selected text;
adding each eligible entity to a training entity pool if the selected text for the eligible entity is determined to be sufficient to represent the entity, wherein entity embeddings corresponding to entities in the training entity pool are trained using an entity embedding model;
preparing, on one or more temporary data stores, an initialized entity embedding matrix, where each column of the entity embedding matrix corresponds to one of the entities in the training entity pool; and
training, using the entity embedding model, entity embeddings in the initialized entity embedding matrix, wherein the entity embedding model uses a stochastic gradient descent process with a gradient obtained via backpropagation.

7. The method of claim 6, wherein the entity embedding model is a distributed memory model.

8. The method of claim 7, wherein training the entity embeddings comprises:
associating, for each entity in the training entity pool, an entity identifier for the entity and the corresponding initialized entity embedding in the initialized entity embedding matrix;
retrieving, for each entity in the training entity pool, term embeddings corresponding to terms in the selected text from the term embedding matrix; and
iteratively training the initialized entity embedding matrix using the stochastic gradient descent process, wherein the stochastic gradient descent process comprises:
sampling, for each entity in the training entity pool, a term sequence of k terms from the selected text, wherein the term sequence is sampled from a sliding window over the selected text, and wherein k is a fixed-length of the term sequence; and
performing a backpropagation process on a current iteration of the initialized entity embedding matrix in order to maximize, for each entity embedding in the entity embedding matrix, a probability that an embedding vector that is a combination of the entity embedding and term embeddings corresponding to the first k-1 terms of the sampled term sequence correctly predicts a k-th term in the term sequence.

9. The method of claim 8, wherein the combination of the entity embedding and term embeddings comprises taking an average of the entity embedding and the term embeddings.

10. The method of claim 8, wherein the combination of the entity embedding and term embeddings comprises concatenating the entity embedding with the term embeddings.

11. The method of claim 6, wherein the entity embedding model is a distributed bag-of-words model.

12. The method of claim 11, wherein training the entity embeddings comprises:
associating, for each entity in the training entity pool, an entity identifier for the entity and the corresponding initialized entity embedding in the initialized entity embedding matrix; and
iteratively training the initialized entity embedding matrix using the stochastic gradient descent process, wherein the stochastic gradient descent process comprises:
sampling, for each entity in the training entity pool, a term sequence of k-terms from the selected text, wherein the term sequence is sampled from a sliding window over the selected text, and wherein k is a fixed-length of the term sequence; and
performing a backpropagation process on a current iteration of the initialized entity embedding matrix in order to maximize, for each entity embedding in the entity embedding matrix, a probability that the entity embedding correctly predicts each term in the sampled term sequence.

13. The method of claim 3, wherein creating the new entity embedding matrix comprises:
identifying, from one or more verticals on the online social network, eligible entities in the online social network;
selecting, for each eligible entity, text to be used for generating an entity embedding corresponding to the entity, wherein the selected text has a determined probability of being relevant to the entity greater than a threshold probability;
determining, for each eligible entity, whether the selected text is sufficient to represent the entity, wherein the determination is based on an amount of the selected text;
adding each eligible entity to an inference entity pool if the selected text for the eligible entity is determined not sufficient to represent the entity, wherein entity embeddings corresponding to entities in the inference entity pool are inferred from trained entity embeddings; and
generating, for each entity in the inference entity pool, an entity embedding by performing an embedding interpolation; and
adding the generated entity embedding into the entity embedding matrix.

14. The method of claim 13, wherein the embedding interpolation for each entity in the inference entity pool comprises:
identifying, from a social graph of the online social network, one or more neighboring entities of the entity that have entity embeddings stored in the one or more temporary data stores;
determining a weight for each edge connecting the entity and each of the identified one or more neighboring entity; and
generating an entity embedding corresponding to the entity by taking a weighted average of entity embeddings corresponding to the identified neighboring entities, wherein the applied weights in the weighted average are normalized so that a sum of the weights is 1.

15. The method of claim 14, wherein the weight for each edge is proportional to the number of co-visits by users of the online social network to the entity and the identified neighboring entity.

16. The method of claim 13, wherein if a first entity in the inference entity pool has no neighboring entities in a social graph of the online social network with an entity embedding stored in the one or more temporary data stores, then the embedding interpolation for the first entity comprises:
determining a weight for each edge connecting two entities within a threshold degree of separation of the first entity in the social graph;
calculating a number of recorded visits per entity by performing repeated random walk with restart procedures on the social graph for a pre-determined number of times, where a random walk with restart procedure comprises:
setting a node representing the first entity to a source node;
walking from the source node to a neighboring destination node, wherein walking to the destination node makes the destination node a source node for a next walk, wherein if more than one neighboring nodes are available from the source node, the neighboring destination node is randomly chosen based on the determined weights on the edges between the source node and the neighboring nodes;
repeating the walks for a randomly chosen number of times;
recording, at the end of the walks for the randomly chosen number of times, a second entity represented by the destination node if the second entity has a corresponding entity embedding;
calculating, for each of the recorded second entities, a similarity of the first entity to the second entity based on a number of recorded visits to the second entity out of a total number of recorded visits; and
generating an entity embedding for the first entity by taking a weighted average of entity embeddings corresponding to the recorded second entities, wherein the applied weights in the weighted average are proportional to the calculated similarities, and wherein the applied weights are normalized so that a sum of the weights is 1.

17. The method of claim 1, wherein generating the query embedding comprises:
parsing the search query to identify one or more unique entities associated with the online social network referenced in the search query;
generating, using a term embedding model, one or more term embeddings representing the one or more n-grams of the search query, respectively, wherein each term embedding is a point in a d-dimensional embedding space, and wherein each term embedding for an n-gram referencing one of the unique entities is a term embedding for the respective unique entity;
generating, using the entity embedding model, a query embedding using the generated term embeddings corresponding to the search query.

18. The method of claim 1, wherein entities comprise one or more of pages, groups, or users.

19. One or more computer-readable non-transitory storage media embodying software that is operable when executed to:
receive, from a client system associated with a user of an online social network, a search query for entities in the online social network, the search query comprising one or more n-grams;
generate, using an entity embedding model, a query embedding corresponding to the search query, wherein the query embedding represents the search query as a point in a d-dimensional embedding space;
retrieve, from one or more production data stores, a plurality of entity embeddings corresponding to a plurality of entities, respectively, wherein each entity embedding represents the corresponding entity as a point in the d-dimensional embedding space, and wherein the entity embeddings in the production data stores are generated using the entity embedding model;
calculate, for each of the retrieved entity embeddings, a similarity metric between the query embedding and the entity embedding, wherein the similarity metric measures a degree of similarity of the query embedding to the entity embedding;
rank the entities based on their respective calculated similarity metrics; and
send, to the client system in response to the search query, instructions for presenting a search-results interface, the search-results interface comprising one or more search results corresponding to one or more of the entities, respectively, the one or more search results being presented in ranked order based on the rankings of their corresponding entities.

20. A system comprising: one or more processors; and a non-transitory memory coupled to the processors comprising instructions executable by the processors, the processors operable when executing the instructions to:
receive, from a client system associated with a user of an online social network, a search query for entities in the online social network, the search query comprising one or more n-grams;
generate, using an entity embedding model, a query embedding corresponding to the search query, wherein the query embedding represents the search query as a point in a d-dimensional embedding space;
retrieve, from one or more production data stores, a plurality of entity embeddings corresponding to a plurality of entities, respectively, wherein each entity embedding represents the corresponding entity as a point in the d-dimensional embedding space, and wherein the entity embeddings in the production data stores are generated using the entity embedding model;
calculate, for each of the retrieved entity embeddings, a similarity metric between the query embedding and the entity embedding, wherein the similarity metric measures a degree of similarity of the query embedding to the entity embedding;
rank the entities based on their respective calculated similarity metrics; and
send, to the client system in response to the search query, instructions for presenting a search-results interface, the search-results interface comprising one or more search results corresponding to one or more of the entities, respectively, the one or more search results being presented in ranked order based on the rankings of their corresponding entities.
